(19) United States
(12) Patent Application Publication
(10) Pub. No.: US 2023/0298008 A1
(43) Pub. Date: Sep. 21, 2023

(54) OMNIVERSE PLATFORM FOR PREDICTIVE DIGITAL ASSET IDENTIFICATION AND RECOMMENDATION IN DIFFERENT METAVERSES

(71) Applicant: PAYPAL, INC., San Jose, CA (US)

(72) Inventor: Pankaj Sarin, Fremont, CA (US)

(21) Appl. No.: 17/697,806

(22) Filed: Mar. 17, 2022

(51) Int. Cl. G06Q 20/36; G06Q 20/38

(52) U.S. Cl. CPC G06Q 20/3678; G06Q 20/389; G06Q 20/382

(57) ABSTRACT

Methods and systems described herein may implement blockchain cryptocurrency transactions in a variety of environments. An online transaction processor may provide operations for digital asset recommendations and processing in one or more metaverses. The online transaction processor may determine digital assets available to a user in one or more digital wallets, as well as interactions by the user in one or more metaverses. Based on the digital assets, the transaction processor may determine blockchains preferred by the user. The transaction processor may intelligently select, using one or more machine learning models, a recommendation of a digital asset for the user based on the preferred blockchains and the interactions by the user in the metaverse(s). The recommendation may be for a digital asset that may be used in one or more of the metaverses and may be based on a proof of interest-based pricing model.

### TECHNICAL FIELD

The present disclosure generally relates to blockchain technology and hardware and software related thereto. More specifically, the present disclosure relates to systems and methods for implementing blockchain in a variety of environments, including digital asset recommendation and purchase in metaverses.

### BACKGROUND

Users may utilize online electronic transaction processors to process transactions between end users as well as exchange and transfer funds. This may include transactions on digital merchant marketplaces and the like. As metaverses become more common and prevalent, users may also conduct online transactions and engage in purchase and sale of digital assets throughout these metaverses. Users may have available digital assets, including cryptocurrency, non-fungible tokens (NFTs), and other digital assets that utilize blockchains for purchase, sale, transfer, or the like of those digital assets through different transactions. These digital assets may have a corresponding value on different platforms (e.g., cryptocurrency and/or NFT trading or exchange platforms), as well as in different metaverses where the digital assets may be used, interacted with, and/or viewed by the user and other users.

Users and/or other metaverse participants may have available digital wallets having digital assets available in one or more metaverses based on different preferences, policies, and/or prices. Thus, users may want to purchase additional digital assets available in one or more metaverses, as well as process transactions with other entities (e.g., users, merchants, metaverse virtual property owners or administrators, etc.), but may not have adequate information to determine those digital assets and pricing for the digital assets. For example, users may not have information about interactions with digital assets in metaverses and/or blockchains used for recordation and management of those digital assets over a distributed network. As such, there exists a need for intelligent identification of digital assets in metaverses for users.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 illustrates an environment of an exemplary computing architecture for facilitating one or more blockchain based transactions, according to an embodiment;

FIG. 2 illustrates an environment of an exemplary blockchain network, according to an embodiment;

FIG. 3 illustrates a block diagram of an exemplary blockchain, according to an embodiment;

FIG. 4 illustrates a block diagram of an exemplary transaction message, according to an embodiment;

FIG. 5 illustrates a block diagram of an exemplary transaction broadcast the blockchain network, according to an embodiment;

FIG. 6A illustrates a flow diagram showing steps of an example method for performing a blockchain based transaction, according to an embodiment;

FIG. 6B illustrates a flow diagram showing steps of an example method for performing a blockchain based transaction, according to an embodiment;

FIG. 7A illustrates an example of a privately broadcasted blockchain, according to an embodiment;

FIG. 7B illustrates an example of blockchain misuse, according to an embodiment;

FIG. 8 illustrates a block diagram of a blockchain enabled in-store purchase system, according to an embodiment;

FIG. 9 illustrates a block diagram of a blockchain enabled in-vehicle purchase system, according to an embodiment;

FIG. 10 illustrates a block diagram of a networked system suitable for implementing the processes described herein, according to an embodiment;

FIG. 11A illustrates an exemplary environment of a metaverse where digital assets may be recommended to users based on interactions and blockchain preferences, according to an embodiment;

FIG. 11B illustrates an exemplary diagram of an intelligent digital asset recommendation in one or more metaverses to a user, according to an embodiment;

FIG. 12 illustrates exemplary block diagram of a system architecture for intelligent digital asset recommendations in metaverses to users, according to an embodiment;

FIG. 13 illustrates a flowchart for an omniverse platform for predictive digital asset identification and recommendation in different metaverses, according to an embodiment; and

FIG. 14 illustrates a block diagram of a computer system suitable for implementing one or more components in FIG. 10, according to an embodiment.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized, and structural and functional modifications may be made, without departing from the scope described herein. Various aspects are capable of other embodiments and of being practiced or being carried out in various different ways.

In its broadest sense, blockchain refers to a framework that supports a trusted ledger that is stored, maintained, and updated in a distributed manner in a peer-to-peer network. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others, the distributed ledger represents each transaction where units of the cryptocurrency are transferred between entities. Using a digital currency exchange, a user may buy any value of digital currency or exchange any holdings in digital currencies into worldwide currency or other digital currencies. Each transaction can be verified by the distributed ledger and only verified transactions are added to the ledger. The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger.

Though maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. In some embodiments described herein, blockchains may be utilized cryptocurrency or other digital asset (e.g., virtual currencies, NFTs, virtual assets in metaverses and/or on other online platforms, etc.), and the like in order to provide recommendations to users. A service provider, such as an online transaction processor, may determine digital assets of a user, such as those available in a digital wallet of the user, and may determine blockchains utilized for data storage, asset and/or asset transaction recordation, asset ownership, and the like. Further, the service provider may detect interactions by the user in one or more metaverses, such as by moving in and throughout, performing actions, engaging with other users or objects, and the like. Based on an intelligent system, such as a machine learning (ML) engine having one or more ML models or other artificial intelligence (AI) system, the service provider may intelligently recommend one or more digital assets in one or more metaverses for purchase by the user. The recommendation may also be based on additional interactions by other users, and other available metaverse and/or user data. Further, the digital asset may be made available for purchase to the user via a digital token, which may have a time-to-live (TTL) and/or dynamic price based on user interactions in the metaverse(s).

In this regard, online transaction processors, such as PAYPAL® or VENMO®, may be used to process transactions electronically and/or provide digital asset exchange and trading platforms using cryptocurrency, NFTs, virtual currency, and the like, which may provide users with the functionality to buy, sell, trade, and recommend digital assets to users. For electronic transaction processing and digital asset usage, servicing, and processing services, an online service provider (e.g., an online transaction processor, such as PAYPAL®) may provide account services to users of the online service provider, as well as other entities requesting the services. A user wishing to establish the account may first access the online service provider and request establishment of an account. An account and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may be required to provide financial information, including payment card (e.g., credit/debit card) information, bank account information, gift card information, benefits/incentives, and/or financial investments. In some embodiments, the account creation may establish account funds and/or values, such as by transferring fiat currency, virtual currency, NFTs, and/or cryptocurrency to the account and/or establishing digital assets and/or other credit limits and accounts as accessible to and utilized by the account. Therefore, this may include loading cryptocurrency, NFTs, digital private keys, and the like to the account, digital wallet, and/or online cryptocurrency exchange or another platform, as well as integrating a cryptocurrency wallet (e.g., an offline cold wallet and/or wallet on another cryptocurrency exchange platform). The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services. Once the account of the user is established with the service provider, the user may utilize the account via one or more computing devices, such as a personal computer, tablet computer, mobile smart phone, or the like.

A user may utilize a digital wallet to process payments through a blockchain protocol and network associated with the digital assets. For example, a user may make a cryptocurrency payment to another user or otherwise transfer, buy, and/or sell cryptocurrency or NFTs between digital wallets, nodes, or users, and the like, which transfers ownership of the digital asset and records transaction processing and/or ownership in one or more blocks or ledger records for the blockchain. In this regard, the digital wallet of the user may have one or more digital assets available to the user via the digital wallet, such as through private keys (e.g., that may be stored in a cold digital wallet) and/or accessible through a digital asset exchange platform or service. Digital assets may include cryptocurrency, NFTs (e.g., digital artwork, collectables, metaverse or other virtual items or objects, etc.), virtual currencies or items, or the like that may be available in and/or utilized through one or more metaverses. Digital assets may also be created from virtual objects, scenes, and/or other characteristics in one or more metaverses (e.g., by imaging or recording, recreating, capturing code for recreating or importing in metaverses, etc.). Further, each digital asset may have a corresponding blockchain utilized by the digital asset for asset generation, indication of asset validity and/or series number, transaction recordation, transfer or ownership recordation, and other blockchain functionalities. Based on the blockchains associated with the user's digital assets, the user may have a preference or affinity for one or more particular blockchains and/or corresponding digital assets (cryptocurrency, NFTs, etc.) and the like. The preference or affinity of the user for those blockchains may be intelligently learning and predicted, as well as based on the number of digital assets associated with the blockchain, recency of trading or transacting using digital assets associated with the blockchain, or other parameter associated with the user using and/or interacting with the blockchain or corresponding digital assets.

Thereafter, the transaction processor or other service provider may detect or determine interactions by the user associated with a particular digital wallet and/or other users in one or more metaverses. In general, a metaverse may refer to a virtual world, such as a three-dimensional (3D) virtual world, where users may interact, engage with other users and/or objects, purchase and/or claim objects, virtual real-estate, and the like, or otherwise perform virtual interactions within a virtual and/or online space or world. These interactions may be further performed and/or facilitated through the use of virtual and/or augmented realities, including headsets, wearables, augmented reality displays, and the like. Some metaverses may include virtual worlds and/or may interact with real-world environments. A user's interactions in one or more metaverses may indicate an interest with one or more digital assets in the metaverse(s). For example, a user may view, come into contact or within a range of an object, may utilize or interact with, or may otherwise indicate an interest with a digital asset and/or corresponding virtual object or value for the digital asset. The interactions may occur at a current time, at a past time, and/or over a time period including multiple interactions. Other users' interactions may also be detected, which may similarly indicate an interest or preference for the digital wallet or corresponding virtual object or value. Such interactions by the user or other users may enhance value or likelihood of interest in the corresponding digital assets.

Thereafter, the transaction processor may determine and/or access those preferences or affinities by the user for certain blockchains, as well as corresponding cryptocurrency, NFTs, or other digital assets. The transaction processor may further determine and/or access the interactions by the user in the metaverse(s), as well as other interactions by other users where relevant to the intelligent predictions and recommendations by an AI system (e.g., a ML engine and corresponding ML models). The transaction processor may then predict digital asset to recommend to user based at least on the preferred blockchains of the user and/or those corresponding to the user's digital assets, as well as the interactions by the user in the metaverse(s). The transaction processor may utilize a predictive engine, which may utilize AI, such as one or more ML models, to process the input interactions by the user and the user's preference for certain blockchains. The ML models may be trained based on past interactions by users with corresponding further past purchases or acquisitions of further digital assets in metaverses. The training data may further include data regarding the blockchains used by those users in the past and the corresponding purchases or acquisition of further digital assets. The ML model may also process preferences for cryptocurrency or NFTs by the user, as well as other users' interactions with digital assets in metaverse(s) over time and/or the availability of the digital assets to the user (e.g., a number of the digital assets, cost, etc.). Other data models may also be used including rules-based engines, neural networks (NNs), and the like.

Further, the transaction processor may predict a value of the digital asset in general and/or to the user. For example, the digital asset may be created at a time or after the recommendation based on a virtual object or other virtual characteristic in a metaverse. The digital asset may also have been created but not traded or does not have a set price. The transaction processor may determine a value of the digital asset based on a proof-of-interaction (POI) based pricing model. For example, based on the interactions by the user over time with the digital asset and/or underlying virtual component of one or more metaverses, a price may be set based on predicting the value to the user. If the user often interacts with the item, the price may increase (or decrease if an incentive or discount may be offered to entice the user to purchase). Further, the POI based pricing model may also consider other users' interactions with the digital asset and/or underlying virtual component of a metaverse that a digital object may be based on. In this regard, if users often interact with, trade, or otherwise utilize a digital asset, the asset may increase in value; conversely, if the asset is not interacted with often or at all, the asset may be of low value based on the POI based pricing model. The ML or other data model used to predict and generate the recommendation may also consider an predicted or known price of the digital asset when predicting and generating recommendations of the asset to the user and/or other users.

The digital asset may then be recommended to the user based on the predictive determination by the ML or other data models of the transaction processor. When providing the recommendation to the user, a notification, message, or alert may be provided, which may be transmitted to the user through conventional communication channels (e.g., email, text, instant message, application push message, etc.) or through communication to the user and/or an avatar for the user in one or more metaverses. The recommendation may be location-specific, such as when the user is at or nearby the digital asset or corresponding virtual component in the metaverse. In further embodiments, the recommendation may also be tokenized as a digital token that may be transmitted to the user and/or appear in one or more metaverses. The digital token may have a corresponding TTL and price corresponding to the digital asset. The price for the token may be used to implement and process a purchase of the digital asset, while the TTL may set an expiration time or period for the digital token before the digital token and/or recommendation is invalidated, expires, or ends. The TTL and/or price may be updated based on further interactions by the user and/or other users with the digital asset, as well as the POI based pricing model. Further, the recommendation and/or digital token may also include asset enhancements to the digital asset, such as changes of color, series, shape, size, add-ons or additions, and the like that may enhance or change the digital asset. This may be used to adjust a value of the digital asset, such as by changing or requesting a specific NFT to increase the value or rarity of the NFT.

After the TTL, the recommendation and/or digital token may be invalidated and/or expire. The digital wallet, preferences, and/or data for future recommendations may be updated to reflect that the user did not have interest in the digital asset. However, if the user requests to purchase the digital asset, a transaction processing request may be processed by the transaction processor for the digital asset, which may utilize cryptocurrency, fiat currency, or other payment for the digital asset. Ownership of the digital asset may be transferred to the user, such as by providing a private key to access the digital asset to the user's digital wallet and/or an exchange service managing the user's digital wallet. The transaction, transfer of ownership of the digital asset, and other data may be recorded in the corresponding blockchain as a block or ledger record. Further, after purchase of the digital asset, the user's preferences and/or other recommendations and predictions may be updated with the transaction processors predictive service. In this manner, metaverse-specific digital assets may be located and exchanged in a faster manner, thereby providing improved benefits to metaverses and use of virtual components and digital assets within those metaverses.

Implementations of the present disclosure will now be described in detail with reference to the accompanying Figures. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof

Computing Architecture

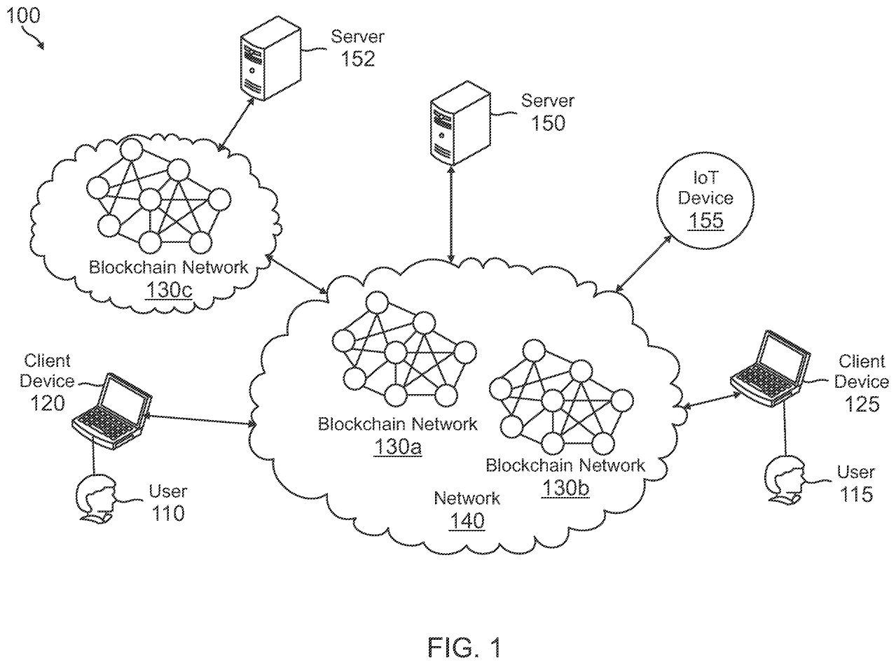

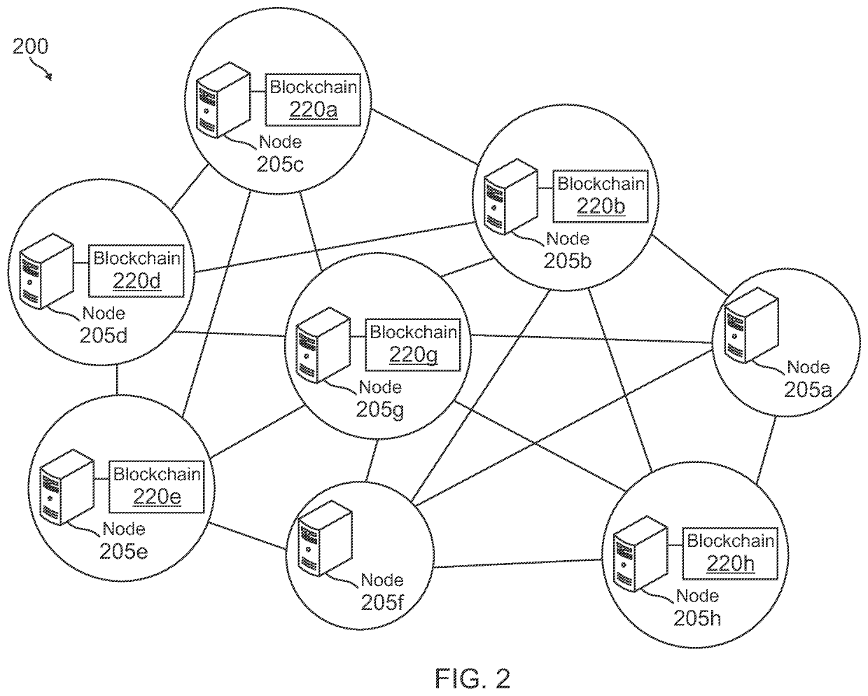

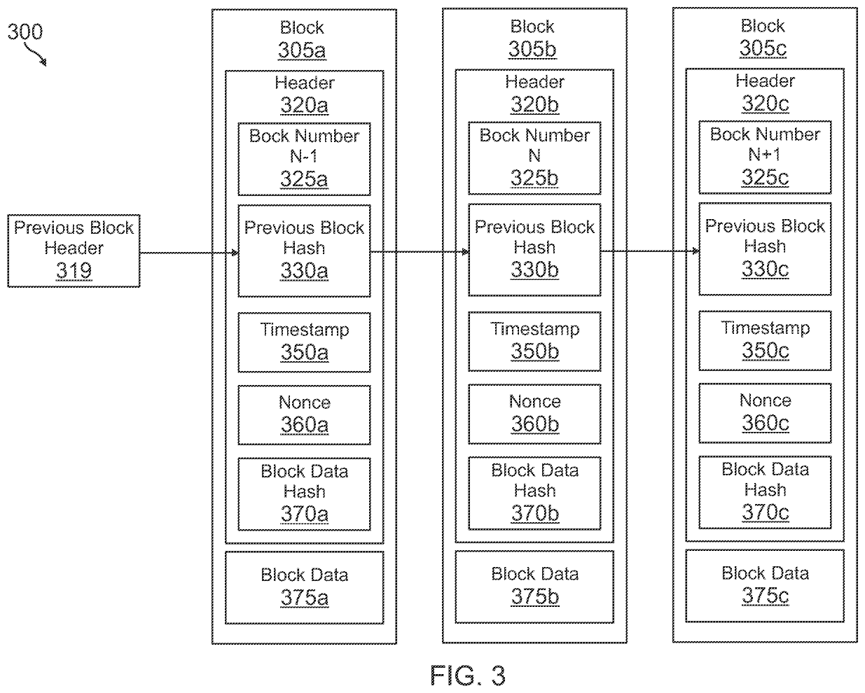

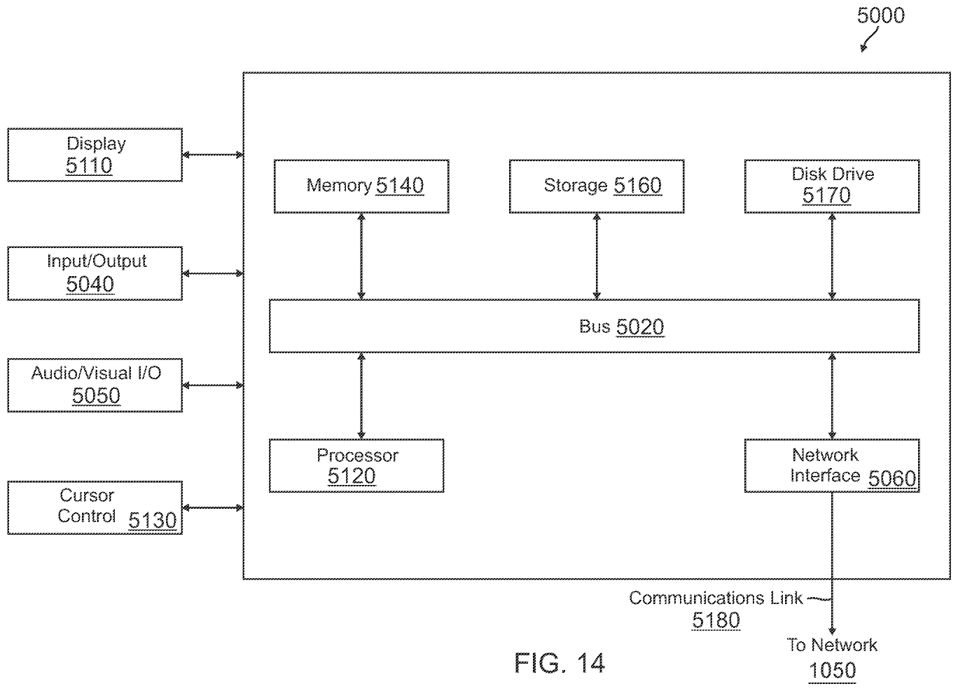

As discussed above, the distributed ledger in a blockchain framework is stored, maintained, and updated in a peer-to-peer network. In one example the distributed ledger maintains a number of blockchain transactions. FIG. 1 shows an example system 100 for facilitating a blockchain transaction. The system 100 includes a first client device 120, a second client device 125, a first server 150, a second server 152, and an Internet of Things (IoT) device 155 interconnected via a network 140. The first client device 120, the second client device 125, the first server 150, and/or the second server 152 may be a computing device 1105 described in more detail with reference to FIG. 14. The IoT device 155 may comprise any of a variety of devices including vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices along with connectivity hardware configured to connect and exchange data. The network 140 may be any of a variety of available networks, such as the Internet, and represents a worldwide collection of networks and gateways to support communications between devices connected to the network 140. The system 100 may also comprise one or more distributed or peer-to-peer (P2P) networks, such as a first, second, and third blockchain networks 130a-c (generally referred to as blockchain networks 130). As shown in FIG. 1, the network 140 may comprise the first and second blockchain networks 130a and 130b. The third blockchain network 130c may be associated with a private blockchain as described below with reference to FIG. 2 and is connected to one or more servers, such as the server 152, and is thus, shown separately from the first and second blockchain networks 130a and 103b. Each blockchain network 130 may comprise a plurality of interconnected devices (or nodes) as described in more detail with reference to FIG. 2. As discussed above, a ledger, or blockchain, is a distributed database for maintaining a growing list of records comprising any type of information. A blockchain, as described in more detail with reference to FIG. 3, may be stored at least at multiple nodes (or devices) of the one or more blockchain networks 130.

In one example, a blockchain based transaction may generally involve a transfer of data or value between entities, such as the first user 110 of the first client device 120 and the second user 115 of the second client device 125 in FIG. 1. Each of the servers 150 and 152 may include one or more applications, for example, a transaction application configured to facilitate the transaction between the entities by utilizing a blockchain associated with one of the blockchain networks 130. As an example, the first user 110 may request or initiate a transaction with the second user 115 via a user application executing on the first client device 120. The transaction may be related to a transfer of value or data from the first user 110 to the second user 115. The first client device 120 may send a request of the transaction to the server 150. The first server 150 and/or the second server 152 may send the requested transaction to one of the blockchain networks 130 to be validated and approved as discussed below.

Blockchain Network

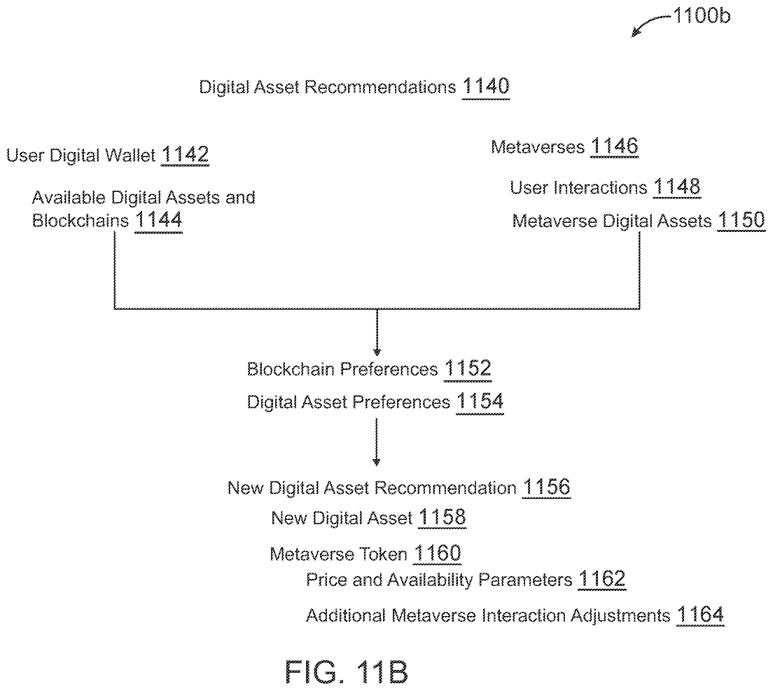

FIG. 2 shows an example blockchain network 200 comprising a plurality of interconnected nodes or devices 205a-h (generally referred to as nodes 205). Each of the nodes 205 may comprise a computing device 1105 described in more detail with reference to FIG. 11. Although FIG. 2 shows a single device for each node 205, each of the nodes 205 may comprise a plurality of devices (e.g., a pool). The blockchain network 200 may be associated with one or more blockchains 220a-h (generally referred to as blockchain 220). Some or all of the nodes 205 may replicate and save an identical copy of the blockchain 220. For example, FIG. 2 shows that the nodes 205b-e and 205g-h store copies of the blockchain 220. The nodes 205b-e and 205g-h may independently update their respective copies of the blockchain 220 as discussed below.

Blockchain Node Types

Blockchain nodes, for example, the nodes 205, may be full nodes or lightweight nodes. Full nodes, such as the nodes 205b-e and 205g-h, may act as a server in the blockchain network 200 by storing a copy of the entire blockchain 220 and ensuring that transactions posted to the blockchain 220 are valid. The full nodes 205b-e and 205g-h may publish new blocks on the blockchain 220. Lightweight nodes, such as the nodes 205a and 205f, may have fewer computing resources than full nodes. For example, IoT devices often act as lightweight nodes. The lightweight nodes may communicate with other nodes 205, provide the full nodes 205b-e and 205g-h with information, and query the status of a block of the blockchain 220 stored by the full nodes 205b-e and 205g-h. In this example, however, as shown in FIG. 2, the lightweight nodes 205a and 205f may not store a copy of the blockchain 220 and thus, may not publish new blocks on the blockchain 220.

Blockchain Network Types

The blockchain network 200 and its associated blockchain 220 may be public (permissionless), federated or consortium, or private. If the blockchain network 200 is public, then any entity may read and write to the associated blockchain 220. However, the blockchain network 200 and its associated blockchain 220 may be federated or consortium if controlled by a single entity or organization. Further, any of the nodes 205 with access to the Internet may be restricted from participating in the verification of transactions on the blockchain 220. The blockchain network 200 and its associated blockchain 220 may be private (permissioned) if access to the blockchain network 200 and the blockchain 220 is restricted to specific authorized entities, for example organizations or groups of individuals. Moreover, read permissions for the blockchain 220 may be public or restricted while write permissions may be restricted to a controlling or authorized entity.

Blockchain

As discussed above, a blockchain 220 may be associated with a blockchain network 200. FIG. 3 shows an example blockchain 300. The blockchain 300 may comprise a plurality of blocks 305a, 305b, and 305c (generally referred to as blocks 305). The blockchain 300 comprises a first block (not shown), sometimes referred to as the genesis block. Each of the blocks 305 may comprise a record of one or a plurality of submitted and validated transactions. The blocks 305 of the blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h, as a file or in a database.

Blocks

Each of the blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3, the block number 325a of the block 305a is N−1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N−1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block. The headers 320 may comprise other data, such as a difficulty target.

The blocks 305 may comprise a respective block data 375a, 375b, and 375c (generally referred to as block data 375). The block data 375 may comprise a record of validated transactions that have also been integrated into the blockchain 200 via a consensus model (described below). As discussed above, the block data 375 may include a variety of different types of data in addition to validated transactions. Block data 375 may include any data, such as text, audio, video, image, or file, that may be represented digitally and stored electronically.

Blockchain Transaction

In one example, a blockchain based transaction may generally involve a transfer of data or value or an interaction between entities and described in more detail below. Referring back to FIG. 1, the first server 150 and/or the second server 152 may include one or more applications, for example, a transaction application configured to facilitate a blockchain transaction between entities. The entities may include users, devices, etc. The first user 110 may request or initiate a transaction with the second user 115 via a user application executing on the first client device 120. The transaction may be related to a transfer of value or data from the first user 110 to the second user 115. The value or data may represent money, a contract, property, records, rights, status, supply, demand, alarm, trigger, or any other asset that may be represented in digital form. The transaction may represent an interaction between the first user 110 and the second user 115.

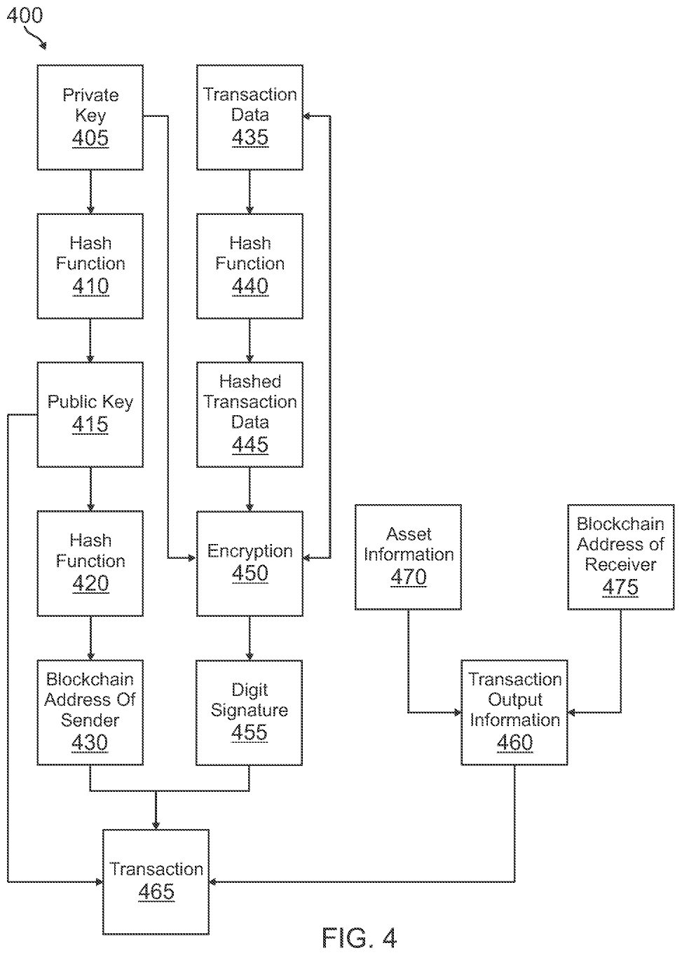

FIG. 4 is a diagram 400 of a transaction 465 generated by the transaction application. The transaction 465 may include a public key 415, a blockchain address 430 associated with the first user 110, a digital signature 455, and transaction output information 460. The transaction application may derive a public key 415 from a private key 405 of the first user 110 by applying a cryptographic hash function 410 to the private key 405. The cryptographic hash function 410 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The transaction application may derive an address or identifier for the first user 110, such as the blockchain address 430, by applying a hash function 420 to the public key 415. Briefly, a hash function is a function that may be used for mapping arbitrary size data to fixed size data. The value may also be referred to as a digest, a hash value, a hash code, or a hash. In order to indicate that the first user 110 is the originator of the transaction 465, the transaction application may generate the digital signature 455 for the transaction data 435 using the private key 405 of the first user 110. The transaction data 435 may include information about the assets to be transferred and a reference to the sources of the assets, such as previous transactions in which the assets were transferred to the first user 110 or an identification of events that originated the assets. Generating the digital signature 455 may include applying a hash function 440 to the transaction data 435 resulting in hashed transaction data 445. The hashed transaction data 445 and the transaction data 435 may be encrypted (via an encryption function 450) using the private key 405 of the first user 110 resulting in the digital signature 455. The transaction output information 460 may include asset information 470 and an address or identifier for the second user 115, such as the blockchain address 475. The transaction 465 may be sent from the first client device 125 to the first server 150.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

Blockchain Addresses

A blockchain network may utilize blockchain addresses to indicate an entity using the blockchain or start and end points in the transaction. For example, a blockchain address for the first user 110, shown in FIG. 4 as the blockchain address of sender 430, may include an alphanumeric string of characters derived from the public key 415 of the first user 110 based on applying a cryptographic hash function 420 to the public key 415. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

Broadcasting Transaction

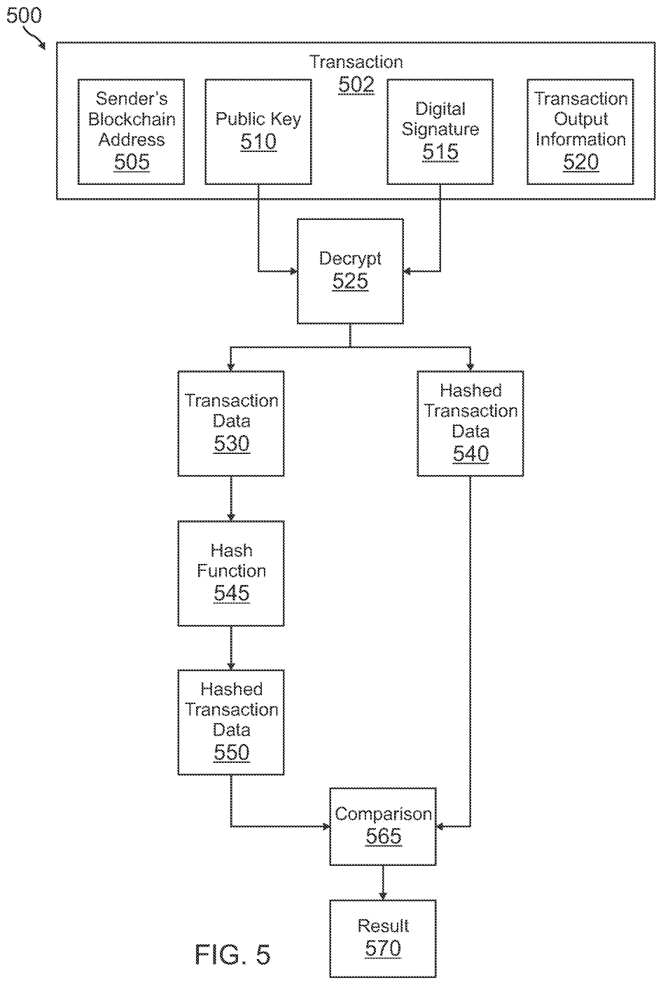

The first server 150 may receive transactions from users of the blockchain network 130. The transactions may be submitted to the first server 150 via desktop applications, smartphone applications, digital wallet applications, web services, or other software applications. The first server 150 may send or broadcast the transactions to the blockchain network 130. FIG. 5 is a diagram 500 showing an example transaction 502 broadcast by the server 150 to the blockchain network 130. The transaction 502 may be broadcast to multiple nodes 205 of the blockchain network 130. Typically, once the transaction 502 is broadcast or submitted to the blockchain network 130, it may be received by one or more of the nodes 205. Once the transaction 502 is received by the one or more nodes 205 of the blockchain network 130, it may be propagated by the receiving nodes 205 to other nodes 205 of the blockchain network 130.

A blockchain network may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcasted to one or more specific nodes based on criteria related to the node's geography, history, reputation, market conditions, docket/delay, technology platform. The rules may be dynamically modified or updated (e.g., turned on or off) to address issues such as latency, scalability and security conditions. A transaction may be broadcast to a subset of nodes as a form of compensation to entities associated with those nodes (e.g., through receipt of compensation for adding a block of one or more transactions to a blockchain).

Transaction Validation—User Authentication and Transaction Data Integrity

Not all the full nodes 205 may receive the broadcasted transaction 502 at the same time, due to issues such as latency. Additionally, not all of the full nodes 205 that receive the broadcasted transaction 502 may choose to validate the transaction 502. A node 205 may choose to validate specific transactions, for example, based on transaction fees associated with the transaction 502. The transaction 502 may include a blockchain address 505 for the sender, a public key 510, a digital signature 515, and transaction output information 520. The node 205 may verify whether the transaction 502 is legal or conforms to a pre-defined set of rules. The node 205 may also validate the transaction 502 based on establishing user authenticity and transaction data integrity. User authenticity may be established by determining whether the sender indicated by the transaction 502 is in fact the actual originator of the transaction 502. User authenticity may be proven via cryptography, for example, asymmetric-key cryptography using a pair of keys, such as a public key and a private key. Additional factors may be considered when establishing user authenticity, such as user reputation, market conditions, history, transaction speed, etc. Data integrity of the transaction 502 may be established by determining whether the data associated with the transaction 502 was modified in any way. Referring back to FIG. 4, when the transaction application creates the transaction 465, it may indicate that the first user 110 is the originator of the transaction 465 by including the digital signature 455.

The node 205 may decrypt the digital signature 515 using the public key 510. A result of the decryption may include hashed transaction data 540 and transaction data 530. The node 205 may generate hashed transaction data 550 based on applying a hash function 545 to the transaction data 530. The node 205 may perform a comparison 565 between the first hashed transaction data 540 and the second hashed transaction data 550. If the result 570 of the comparison 565 indicates a match, then the data integrity of the transaction 502 may be established and node 205 may indicate that the transaction 502 has been successfully validated. Otherwise, the data of the transaction 502 may have been modified in some manner and the node 205 may indicate that the transaction 502 has not been successfully validated.

Each full node 205 may build its own block and add validated transactions to that block. Thus, the blocks of different full nodes 205 may comprise different validated transactions. As an example, a full node 205a may create a first block comprising transactions “A,” “B,” and “C.” Another full node 205b may create a second block comprising transactions “C,” “D,” and “E.” Both blocks may include valid transactions. However, only one block may get added to the blockchain, otherwise the transactions that the blocks may have in common, such as transaction “C” may be recorded twice leading to issues such as double-spending when a transaction is executed twice. One problem that may be seen with the above example is that transactions “C,” “D,” and “E” may be overly delayed in being added to the blockchain. This may be addressed a number of different ways as discussed below.

Securing Keys

Private keys, public keys, and addresses may be managed and secured using software, such as a digital wallet. Private keys may also be stored and secured using hardware. The digital wallet may also enable the user to conduct transactions and manage the balance. The digital wallet may be stored or maintained online or offline, and in software or hardware or both hardware and software. Without the public/private keys, a user has no way to prove ownership of assets. Additionally, anyone with access a user's public/private keys may access the user's assets. While the assets may be recorded on the blockchain, the user may not be able to access them without the private key.

Tokens

A token may refer to an entry in the blockchain that belongs to a blockchain address. The entry may comprise information indicating ownership of an asset. The token may represent money, a contract, property, records, access rights, status, supply, demand, alarm, trigger, reputation, ticket, or any other asset that may be represented in digital form. For example, a token may refer to an entry related to cryptocurrency that is used for a specific purpose or may represent ownership of a real-world asset, such as Fiat currency or real-estate. Token contracts refer to cryptographic tokens that represent a set of rules that are encoded in a smart contract. The person that owns the private key corresponding to the blockchain address may access the tokens at the address. Thus, the blockchain address may represent an identity of the person that owns the tokens. Only the owner of the blockchain address may send the token to another person. The tokens may be accessible to the owner via the owner's wallet. The owner of a token may send or transfer the token to a user via a blockchain transaction. For example, the owner may sign the transaction corresponding to the transfer of the token with the private key. When the token is received by the user, the token may be recorded in the blockchain at the blockchain address of the user.

Establishing User Identity

While a digital signature may provide a link between a transaction and an owner of assets being transferred, it may not provide a link to the real identity of the owner. In some cases, the real identity of the owner of the public key corresponding to the digital signature may need to be established. The real identity of an owner of a public key may be verified, for example, based on biometric data, passwords, personal information, etc. Biometric data may comprise any physically identifying information such as fingerprints, face and eye images, voice sample, DNA, human movement, gestures, gait, expressions, heart rate characteristics, temperature, etc.

Publishing and Validating a Block

As discussed above, full nodes 205 may each build their own blocks that include different transactions. A node may build a block by adding validated transactions to the block until the block reaches a certain size that may be specified by the blockchain rules. However, only one of the blocks may be added to the blockchain. The block to be added to the blockchain and the ordering of the blocks may be determined based on a consensus model. In a proof of work model, both nodes may compete to add their respective block to the blockchain by solving a complex mathematical puzzle. For example, such a puzzle may include determining a nonce, as discussed above, such that a hash (using a predetermined hashing algorithm) of the block to be added to the blockchain (including the nonce) has a value that meets a range limitation. If both nodes solve the puzzle at the same time, then a “fork” may be created. When a full node 205 solves the puzzle, it may publish its block to be validated by the validation nodes 205 of the blockchain network 130.

In a proof of work consensus model, a node validates a transaction, for example, by running a check or search through the current ledger stored in the blockchain. The node will create a new block for the blockchain that will include the data for one or more validated transactions (see, e.g., block data 375 of FIG. 3). In a blockchain implementation such as Bitcoin, the size of a block is constrained. Referring back to FIG. 3, in this example, the block will include a Previous Block Hash 330 representing a hash of what is currently the last block in the blockchain. The block may also include a hash 370 of its own transaction data (e.g., a so-called Merkle hash). According to a particular algorithm, all or selected data from the block may be hashed to create a final hash value. According to an embodiment of the proof of work model, the node will seek to modify the data of the block so that the final hash value is less than a preset value. This is achieved through addition of a data value referred to as a nonce 360. Because final hash values cannot be predicted based on its input, it is not possible to estimate an appropriate value for the nonce 360 that will result in a final hash value that is less than the pre-set value. Accordingly, in this embodiment, a computationally-intensive operation is needed at the node to determine an appropriate nonce value through a “brute force” trial-and-error method. Once a successful nonce value is determined, the completed block is published to the blockchain network for validation. If validated by a majority of the nodes in the blockchain network, the completed block is added to the blockchain at each participating node. When a node's block is not added to the blockchain, the block is discarded and the node proceeds to build a new block. The transactions that were in the discarded block may be returned to a queue and wait to be added to a next block. When a transaction is discarded or returned to the queue, the assets associated with the discarded transaction are not lost, since a record of the assets will exist in the blockchain. However, when a transaction is returned to the queue, it causes a delay in completing the transaction. Reducing the time to complete a transaction may be important. A set of blockchain rules, or renumeration/compensation for a node to process the returned transaction may determine how a returned transaction is to be treated going forward. When a transaction is put into a pool then it can have a priority level but then a rule may indicate that the transaction priority level must exceed a threshold level. The priority level of a returned or discarded transaction may be increased. Another way to reduce the time to complete a transaction is to have the system, service provider, participant in the transaction, or merchant pay additional incentive for nodes to process a returned transaction. As an example, a service provider may identify a network of preferred miners based on geography or based on a volume discount perspective. The time to complete a transaction may be optimized by routing a returned transaction to specific preferred nodes. A transaction may be associated with an address that limits which of the preferred nodes will get to process the transaction if it is returned due to its inclusion in a discarded block. A value may be associated with the transaction so that it goes to preferred miners in a specific geographic location. Additionally, returned transactions may be processed based on pre-set rules. For example, a rule may indicate a commitment to process a specific number of returned transactions to receive additional incentive or compensation.

Blockchain Confirmations

After a block comprising a transaction is added to a blockchain, a blockchain confirmation may be generated for the transaction. The blockchain confirmation may be a number of blocks added to the blockchain after the block that includes the transaction. For example, when a transaction is broadcasted to the blockchain, there will be no blockchain confirmations associated with the transaction. If the transaction is not validated, then the block comprising the transaction will not be added to the blockchain and the transaction will continue to have no blockchain confirmations associated with it. However, if a block comprising the transaction is validated, then each of the transactions in the block will have a blockchain confirmation associated with the transaction. Thus, a transaction in a block will have one blockchain confirmation associated with it when the block is validated. When the block is added to the blockchain, each of the transactions in the block will have two blockchain confirmations associated with it. As additional validated blocks are added to the blockchain, the number of blockchain confirmations associated with the block will increase. Thus, the number of blockchain confirmations associated with a transaction may indicate a difficulty of overwriting or reversing the transaction. A higher valued transaction may require a larger number of blockchain confirmations before the transaction is executed.

Consensus Models

As discussed above, a blockchain network may determine which of the full nodes 205 publishes a next block to the blockchain. In a permissionless blockchain network, the nodes 205 may compete to determine which one publishes the next block. A node 205 may be selected to publish its block as the next block in the blockchain based on consensus model. For example, the selected or winning node 205 may receive a reward, such as a transaction fee, for publishing its block, for example. Various consensus models may be used, for example, a proof of work model, a proof of stake model, a delegated proof of stake model, a round robin model, proof of authority or proof of identity model, and proof of elapsed time model.

In a proof of work model, a node may publish the next block by being the first to solve a computationally intensive mathematical problem (e.g., the mathematical puzzle described above). The solution serves as “proof” that the node expended an appropriate amount of effort in order to publish the block. The solution may be validated by the full nodes before the block is accepted. The proof of work model, however, may be vulnerable to a 51% attack described below. The proof of stake model is generally less computationally intensive than the proof of work model. Unlike the proof of work model which is open to any node having the computational resources for solving the mathematical problem, the proof of stake model is open to any node that has a stake in the system. The stake may be an amount of cryptocurrency that the blockchain network node (user) may have invested into the system. The likelihood of a node publishing the next block may be proportional to its stake. Since this model utilizes fewer resources, the blockchain may forego a reward as incentive for publishing the next block. The round robin model is generally used by permissioned blockchain networks. Using this model, nodes may take turns to publish new blocks. In the proof of elapsed time model, each publishing node requests a wait time from a secure hardware within their computer system. The publishing node may become idle for the duration of the wait time and then creates and publishes a block to the blockchain network. As an example, in cases where there is a need for speed and/or scalability (e.g., in the context of a corporate environment), a hybrid blockchain network may switch to be between completely or partially permissioned and permissionless. The network may switch based on various factors, such as latency, security, market conditions, etc.

Forks

As discussed above, consensus models may be utilized for determining an order of events on a blockchain, such as which node gets to add the next block and which node's transaction gets verified first. When there is a conflict related to the ordering of events, the result may be a fork in the blockchain. A fork may cause two versions of the blockchain to exist simultaneously. Consensus methods generally resolve conflicts related to the ordering of events and thus, prevent forks from occurring. In some cases, a fork may be unavoidable. For example, with a proof of work consensus model, only one of the nodes competing to solve a puzzle may win by solving its puzzle first. The winning node's block is then validated by the network. If the winning node's block is successfully validated by the network, then it will be the next block added to the blockchain. However, it may be the case that two nodes may end up solving their respective puzzles at the same time. In such a scenario, the blocks of both winning nodes may be broadcasted to the network. Since different nodes may receive notifications of a different winning node, the nodes that receive notification of the first node as the winning node may add the first node's block to their copy of the blockchain. Nodes that receive notification of the second node as the winning node may add the second node's block to their copy of the blockchain. This results in two versions of the blockchain or a fork. This type of fork may be resolved by the longest chain rule of the proof of work consensus model. According to the longest chain rule, if two versions of the blockchain exist, then the network the chain with a larger number of blocks may be considered to be the valid blockchain. The other version of the blockchain may be considered as invalid and discarded or orphaned. Since the blocks created by different nodes may include different transactions, a fork may result in a transaction being included in one version of the blockchain and not the other. The transactions that are in a block of a discarded blockchain may be returned to a queue and wait to be added to a next block.

In some cases, forks may result from changes related to the blockchain implementation, for example, changes to the blockchain protocols and/or software. Forks may be more disruptive for permissionless and globally distributed blockchain networks than for private blockchain networks due to their impact on a larger number of users. A change or update to the blockchain implementation that is backwards compatible may result in a soft fork. When there is a soft fork, some nodes may execute the update blockchain implementation while other nodes may not. However, nodes that do not update to the new blockchain implementation may continue to transact with updated nodes.

A change to the blockchain implementation that is not backwards compatible may result in a hard fork. While hard forks are generally intentional, they may also be caused by unintentional software bugs/errors. In such a case, all publishing nodes in the network may need to update to the new blockchain implementation. While publishing nodes that do not update to the new blockchain implementation may continue to publish blocks according to the previous blockchain implementation, these publishing nodes may reject blocks created based on the new blockchain implementation and continue to accept blocks created based on the previous blockchain implementation. Therefore, nodes on different hard fork versions of the blockchain may not be able to interact with one another. If all nodes move to the new blockchain implementation, then the previous version may be discarded or abandoned. However, it may not be practical or feasible to update all nodes in the network to a new blockchain implementation, for example, if the update invalidates specialized hardware utilized by some nodes.

Blockchain-Based Application: Cryptocurrency

Cryptocurrency is a medium of exchange that may be created and stored electronically in a blockchain, such as a the blockchain 130a in FIG. 1. Bitcoin is one example of cryptocurrency, however there are several other cryptocurrencies. Various encryption techniques may be used for creating the units of cryptocurrency and verifying transactions. As an example, the first user 110 may own 10 units of a cryptocurrency. The blockchain 130a may include a record indicating that the first user 110 owns the 10 units of cryptocurrency. The first user 110 may initiate a transfer of the 10 units of cryptocurrency to the second user 115 via a wallet application executing on the first client device 120. The wallet application may store and manage a private key of the first user 110. Examples of the wallet device include a personal computer, a laptop computer, a smartphone, a personal data assistant (PDA), etc.

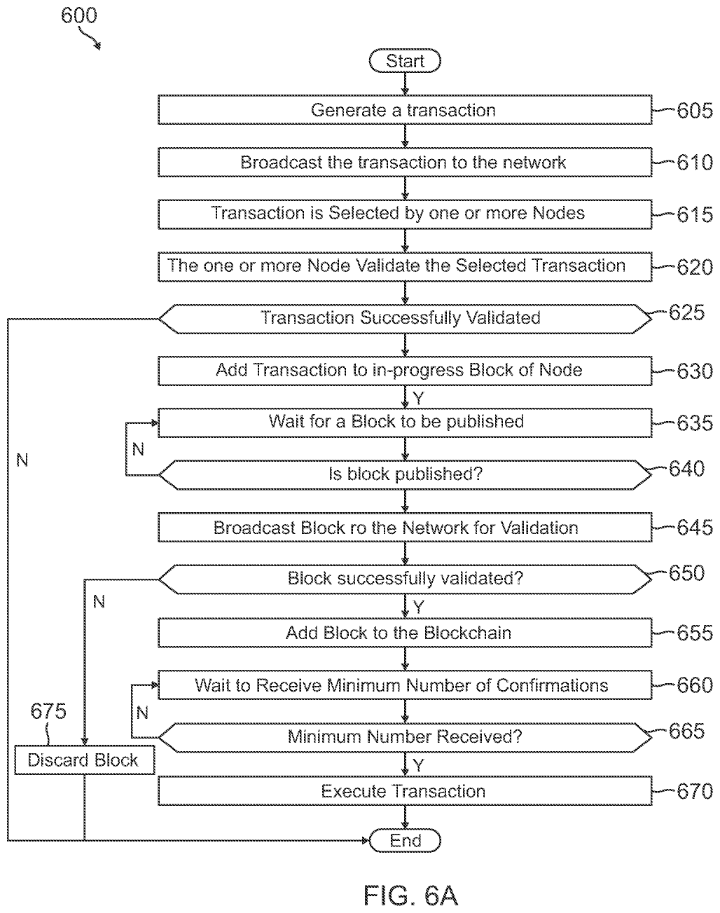

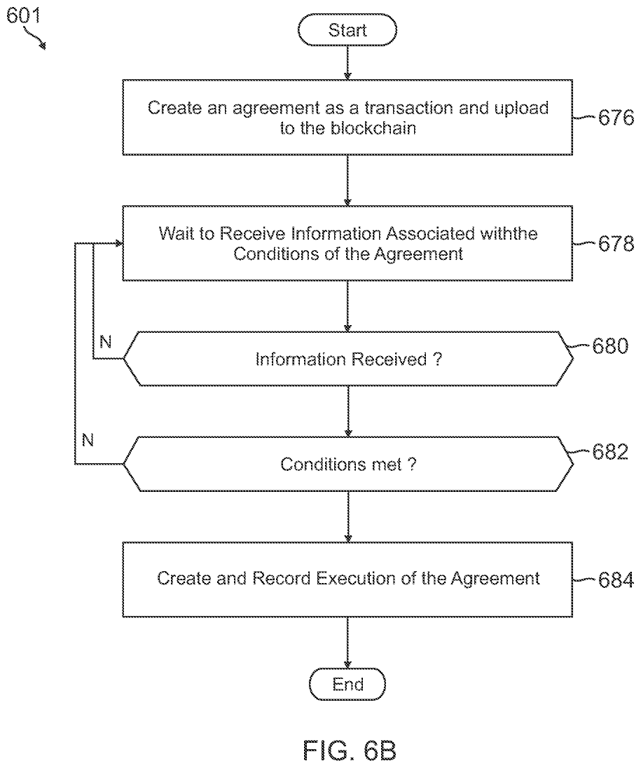

FIG. 6A is a flow diagram showing steps of an example method 600 for performing a blockchain transaction between entities, such as the first user 110 of the first client device 120 and the second user 115 of the second client device 125 in FIG. 1. The steps of the method 600 may be performed by any of the computing devices shown in FIG. 1. Alternatively or additionally, some or all of the steps of the method 600 may be performed by one or more other computing devices. Steps of the method 600 may be modified, omitted, and/or performed in other orders, and/or other steps added.

At step 605, the wallet application may generate transaction data for transferring the 10 units of cryptocurrency from the first user 110 to the second user 120. The wallet application may generate a public key for the transaction using the private key of the first user 110. In order to indicate that the first user 110 is the originator of the transaction, a digital signature may also be generated for the transaction using the private key of the first user 110. As discussed with reference to FIG. 4, the transaction data may include information, such as a blockchain address of the sender 430, the digital signature 455, transaction output information 460, and the public key of the sender 415. The transaction data may be sent to the first server 150 from the first client device 125.

The first server 150 may receive the transaction data from the first client device 125. At step 610, the first server 150 may broadcast the transaction to the blockchain network 130a. The transaction may be received by one or more nodes 205 of the blockchain network 130a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. Validating the transaction may include determining whether the transaction is legal or conforms to a pre-defined set of rules for that transaction, establishing user authenticity, and establishing transaction data integrity. At step 625, if the transaction is successfully validated by a node 205, the validated transaction is added to a block being constructed by that node 205 (step 630). As discussed above, since different nodes 205 may choose to validate different transactions, different nodes 205 may build or assemble a block comprising different validated transactions. Thus, the transaction associated with the first user 110 transferring 10 units of cryptocurrency to the second user 115 may be included in some blocks and not others.

At step 635, the blockchain network 130a may wait for a block to be published. Validated transactions may be added to the block being assembled by a node 205 until it reaches a minimum size specified by the blockchain. If the blockchain network 130a utilizes a proof of work consensus model, then the nodes 205 may compete for the right to add their respective blocks to the blockchain by solving a complex mathematical puzzle. The node 205 that solves its puzzle first wins the right to publish its block. As compensation, the winning node may be awarded a transaction fee associated with the transaction (e.g., from the wallet of the first user 110). Alternatively, or in addition, the winning node may be awarded compensation as an amount of cryptocurrency added to an account associated with the winning node from the blockchain network (e.g., “new” units of cryptocurrency entering circulation). This latter method of compensation and releasing new units of cryptocurrency into circulation is sometimes referred to as “mining.” At step 640, if a block has not been published, then the process 600 returns to step 635 and waits for a block to be published. However, at step 640, if a block has been published, then the process 600 proceeds to step 645.

At step 645, the published block is broadcast to the blockchain network 130a for validation. At step 650, if the block is validated by a majority of the nodes 205, then at step 655, the validated block is added to the blockchain 220. However, at step 650, if the block is not validated by a majority of the nodes 205, then the process 600 proceeds to step 675. At step 675, the block is discarded and the transactions in the discarded block are returned back to the queue. The transactions in the queue may be selected by one or more nodes 205 for the next block. The node 205 that built the discarded block may build a new next block.

At step 660, if the transaction was added to the blockchain 220, the server 150 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and assets from the first user 110 may be transferred to the second user 115. For example, the 10 units of cryptocurrency owned by the first user 110 may be transferred from a financial account of the first user 110 to a financial account of the second user 115 after the transaction receives at least three confirmations.

Smart Contracts

A smart contract is an agreement that is stored in a blockchain and automatically executed when the agreement's predetermined terms and conditions are met. The terms and conditions of the agreement may be visible to other users of the blockchain. When the pre-defined rules are satisfied, then the relevant code is automatically executed. The agreement may be written as a script using a programming language such as Java, C++, JavaScript, VBScript, PHP, Perl, Python, Ruby, ASP, Tcl, etc. The script may be uploaded to the blockchain as a transaction on the blockchain.

As an example, the first user 110 (also referred to as tenant 110) may rent an apartment from the second user 115 (also referred to as landlord 115). A smart contract may be utilized between the tenant 110 and the landlord 115 for payment of the rent. The smart contract may indicate that the tenant 110 agrees to pay next month's rent of $1000 by the 28^{th} of the current month. The agreement may also indicate that if the tenant 110 pays the rent, then the landlord 115 provides the tenant 110 with an electronic receipt and a digital entry key to the apartment. The agreement may also indicate that if the tenant 110 pays the rent by the 28^{th} of the current month, then on the last day of the current month, both the entry key and the rent are released respectively to the tenant 110 and the landlord 115.

FIG. 6B is a flow diagram showing steps of an example method 601 for performing a smart contract transaction between entities, such as the tenant 110 and the landlord 115. The steps of the method 601 may be performed by any of the computing devices shown in FIG. 1. Alternatively or additionally, some or all of the steps of the method 601 may be performed by one or more other computing devices. Steps of the method 601 may be modified, omitted, and/or performed in other orders, and/or other steps added.

At step 676, the agreement or smart contract between the tenant 110 and the landlord 115 may be created and then submitted to the blockchain network 130a as a transaction. The transaction may be added to a block that is mined by the nodes 205 of the blockchain network 130a, the block comprising the transaction may be validated by the blockchain network 130a and then recorded in the blockchain 220 (as shown in steps 610-655 in FIG. 6A). The agreement associated with the transaction may be given a unique address for identification.

At step 678, the process 601 waits to receive information regarding the conditions relevant for the agreement. For example, the process 601 may wait to receive notification that $1000 was sent from a blockchain address associated with the tenant 110 and was received at a blockchain address associated with the landlord 115 by the 28th of the current month. At step 680, if such a notification is not received, then the process 601 returns to step 678. However, if at step 680, a notification is received, then the process 601 proceeds to step 682.

At step 682, based on determining that the received notification satisfies the conditions needed to trigger execution of the various terms of the smart contract, the process 601 proceeds to step 684. However, at step 682, if it is determined that the received notification does not satisfy the conditions needed to trigger execution of the smart contract, then the process 601 returns to step 678. At step 684, the process 601 creates and records a transaction associated with execution of the smart contract. For example, the transaction may include information of the payment received, the date the payment was received, an identification of the tenant 110 and an identification of the landlord 115. The transaction may be broadcast to the blockchain network 130a and recorded in the blockchain 220 (as shown in steps 610-655 of the process 600 of FIG. 6A). If the transaction is successfully recorded in the blockchain 220, the transaction may be executed. For example, if the payment was received on the 28th, then an electronic receipt may be generated and sent to the tenant 110. However, on the last day of the current month, both the digital entry key and the rent are released respectively to the tenant 110 and the landlord 115.

Smart contracts may execute based on data received from entities that are not on the blockchain or off-chain resources. For example, a smart contract may be programmed to execute if a temperature reading from a smart sensor or IoT sensor falls below 10 degrees. Smart contracts are unable to pull data from off-chain resources. Instead, such data needs to be pushed to the smart contract. Additionally, even slight variations in data may be problematic since the smart contract is replicated across multiple nodes of the network. For example, a first node may receive a temperature reading of 9.8 degrees and a second node may receive a temperature reading of 10 degrees. Since validation of a transaction is based on consensus across nodes, even small variations in the received data may result in a condition of the smart contract to be evaluated as being not satisfied. Third party services may be utilized to retrieve off-chain resource information and push this to the blockchain. These third-party services may be referred to as oracles. Oracles may be software applications, such as a big data application, or hardware, such as an IoT or smart device. For example, an oracle service may evaluate received temperature readings beforehand to determine if the readings are below 10 degrees and then push this information to the smart contract. However, utilizing oracles may introduce another possible point of failure into the overall process. Oracles may experience errors, push incorrect information or may even go out of business.

Since blockchains are immutable, amending or updating a smart contract that resides in a blockchain may be challenging and thus, more expensive and/or more restrictive than with text-based contracts.

Blockchain Enabled In-Store Purchasing

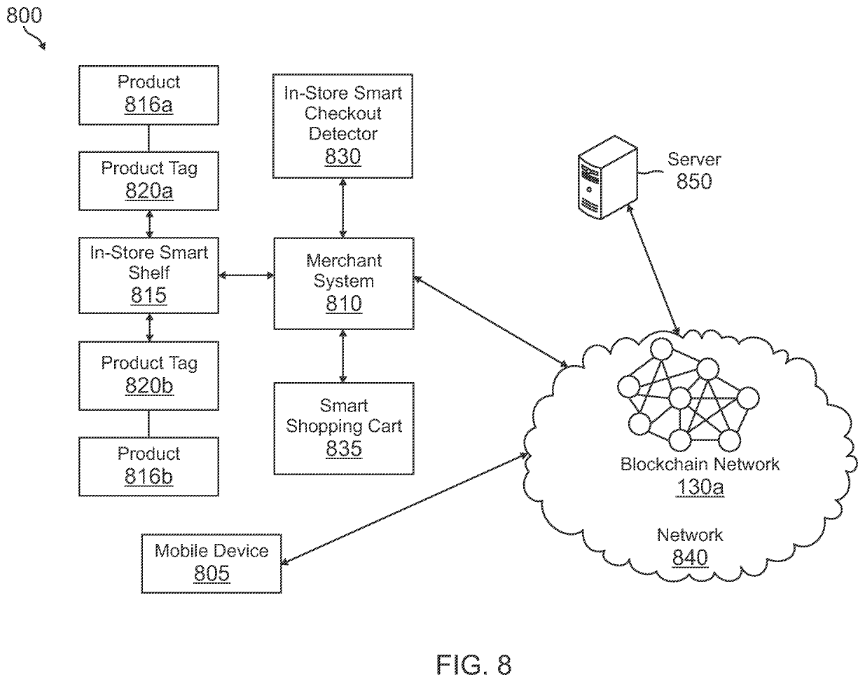

An example of blockchain enabled in-store purchasing is described with reference to the system 800 shown in FIG. 8, the process 600 shown in FIG. 6A and the process 601 shown in FIG. 6B. FIG. 8 illustrates an example of a blockchain enabled in-store purchase system 800. The system 800 includes a mobile device 805, a merchant system 810, and a server 850 connected via a network 840. The merchant system 810 may be connected via a local wireless network to various IoT devices within a store, for example, an in-store smart shelf 815, and an in-store smart checkout detector 830.

The store may include one or more smart shelves, such as the in-store smart shelf 815. The smart shelf 815 may include an RFID tag, an RFID reader, and an antenna. One or more products may be stored on the in-store smart shelf 815. Each product may include an RFID tag, such as a first product tag 820a attached to a first product 816a and a second product tag 820b attached to a second product 816b. The in-store smart shelf 815 may, based on reading the product tags 820a and 820b, send information about the products 816a and 816b throughout the day to the merchant system 810. The merchant system 810 may in turn update an inventory of products currently within the store.

A shopper may travel through the store with the mobile device 805. A digital shopping list on the mobile device 805 may include a list of items that the shopper may need to purchase. For example, the shopping list may include an item that matches the first product 816a. When the shopper is close to the in-store smart shelf 815, the mobile device 805 may notify the shopper that the first product 816a is currently available on the in-store smart shelf 815. The shopper may remove the first product 816a from the in-store smart shelf 815 and place it into a smart shopping cart 835. The smart shopping cart 835 may read the first product tag 820a as well as the product tags attached to other products that may have been placed in the smart shopping cart 835. When the shopper is ready to checkout, the shopper may walk out of the store with the shopping cart 835. As the shopper walks out of the store, the in-store smart checkout detector 830 may detect the smart shopping cart 835. The smart shopping cart 835 may communicate with the in-store smart checkout detector 830 and transmit information about the products in the smart shopping cart. The in-store smart checkout detector 830 may send information about the products, such as the first product 816a, and payment information from the mobile device 805 to the merchant system 810. The merchant system 810 may receive information from the in-store smart checkout detector 830 and the payment information and proceed to initiate purchase of the first product 816a.

Referring to step 605 of the process 600 shown in FIG. 6A, a wallet application on the mobile device 805 may generate transaction data for transferring an amount of cryptocurrency matching the sale price of the first product 816a from the shopper to the merchant. The wallet application may generate a public key for the transaction using the private key of the shopper. In order to indicate that the shopper is the originator of the transaction, a digital signature may also be generated for the transaction using the private key of the shopper. The transaction data may be sent to the server 850 from the mobile device 805.

The server 850 may receive the transaction data from the mobile device 805. At step 610, the server 850 may broadcast the transaction to the blockchain network 130a. The transaction may be received by one or more nodes 205 of the blockchain network 130a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. At step 625, if the transaction is successfully validated by a node 205, the validated transaction is added, at step 630, to a block being constructed by that node 205. At step 635, the blockchain network 130a may wait for a block to be published. At step 640, if a block has not been published, then the process 600 returns to step 635 and waits for a block to be published. However, at step 640, if a block has been published, then the process 600 proceeds to step 645.

At step 645, the published block is broadcast to the blockchain network 130a for validation. At step 650, if the block is validated by a majority of the nodes 205, then at step 655, the validated block is added to the blockchain 220. At step 660, if the transaction was added to the blockchain 220, the server 850 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and the sale price of the first product 816a may be transferred from the shopper to the merchant.

When the in-store smart checkout detector 830 sends information about the products, such as the first product 816a, and payment information from the mobile device 805 to the merchant system 810, a smart contract may be created between the shopper and the merchant and executed according to the process 601 shown in FIG. 6B. For example, at step 676, a smart contract between the shopper and the merchant may be created and then submitted to the blockchain network 130a as a transaction. For example, at step 678, the process 601 may wait to receive notification that an amount of cryptocurrency equal to the sale price of the first product 816a was sent from a blockchain address associated with the shopper and was received at a blockchain address associated with the merchant by the time the first product 816a is removed from the smart shopping cart 835. If the payment for the first product 816a was successfully transferred from the shopper to the merchant by the time the shopper removes the first product 816a from the smart shopping cart 835, then an electronic receipt may be generated and sent to the shopper. Otherwise, the merchant system 815 may be alerted that the shopper is attempting to leave the premises without paying for the first product 816a.

Blockchain Enabled In-Vehicle Purchasing

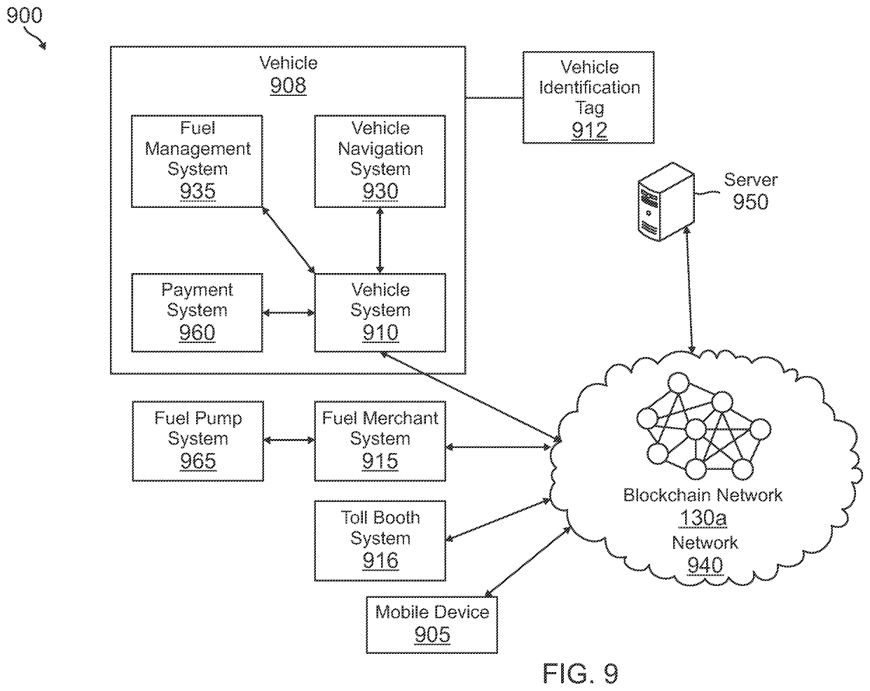

An example of blockchain enabled in-vehicle purchasing is described with reference to the system 900 shown in FIG. 9, the process 600 shown in FIG. 6A and the process 601 shown in FIG. 6B. FIG. 9 illustrates an example system 900 for blockchain enabled in-vehicle purchasing. The system 900 includes an IoT enable smart vehicle 908. The vehicle 908 may include one or more computing devices implementing a vehicle system 910, a vehicle navigation system 930, a payment system 960 and a fuel management system 935. The vehicle 908 may include a RFID tag, such as a vehicle identification tag 912. The system 900 may also include various merchant systems, such as a fuel merchant system 915, and a toll booth system 916. The system 900 may also include a mobile device 905 belonging to a driver of the vehicle 908.

When the driver gets into the vehicle 908, payment information may be loaded from the driver's mobile device 905 into the vehicle payment system 910 so it is available for secure payments to other devices in order to complete in-vehicle purchases, such as in-vehicle purchase of fuel and in-vehicle payment of tolls. The driver of the smart vehicle may pay for parking, fast food, using the IoT enabled smart vehicle 908. Additionally, the IoT enabled smart vehicle 908 may also facilitate in-vehicle purchasing of smartphone apps, music, audio books, and other goods and services.

The fuel management system 935 may perform various functions related to fuel usage and communicate with the vehicle system 916. For example, the fuel management system 935 may monitor fuel usage and based on detecting that the fuel is below a threshold, notify the vehicle system 910. The vehicle system 910 may communicate with the vehicle navigation system 930 to determine nearby fuel stations. The selection of a fuel station to may be based on various factors, such as the availability of fuel at nearby fuel stations, the vehicle's current route and location, incentives that may be offered by nearby fuel stations, etc. The vehicle system 910 may notify the driver about the selection of a fuel station and the vehicle 908 may be re-routed to the selected fuel station. Upon arriving at the selected fuel station, the driver may pull up to a fuel pump. The fuel pump may include a fuel pump system 965 configured to detect the RFID tags of vehicles, such as the vehicle identification tag 912 in order to obtain an identification of the vehicles. The fuel pump system 965 and the payment system 960 may be configured to communicate with each other. The fuel payment system 960 may send payment information to the fuel pump system 965. After the driver has completed re-fueling, the driver may simply drive away. The fuel pump system 965 may send the fuel merchant system 915 information about the identification of the vehicle 908, the amount of fuel purchased, and the payment information. The fuel merchant system 915 may use the information to complete a transaction with the driver for the purchase of the fuel. For example, the fuel merchant system 915 may communicate with the server 950 to charge the driver for the fuel according to the process 600 shown in FIG. 6A. Additionally, the fuel merchant system 915 may communicate with the server 950 in order to create a smart contract between the driver and the fuel merchant. The smart contract may be created and executed according to the process 601 shown in FIG. 6B.

Augmented Reality (AR), Mixed Reality and Blockchain Based E-Commerce

AR or mixed reality enabled devices, such as wearable smart glasses, head mounted devices, holographic devices, or smartphone applications overlay digital content on top of a real world view, thus, enhancing a user's experience of the real world. The overlay content may be 3D models generated based on 3D scanning real world objects. AR enables users to experience online shopping in a virtual environment. For example, using AR, browse virtual stores and view 3D models of items for sale in virtual stores. Just as in the real world, customers may be able to handle and examine various physical details of the products. Blockchain smart contracts may be utilized to provide an e-commerce platform where customers may purchase items from online merchants with cryptocurrency and digital wallets. Information about a product, such as country of origin, materials, ingredients, price, description, measurements, terms and conditions, 3D model of the physical product, etc., may be hashed and recorded in a blockchain. This provides proof of ownership of virtual goods and products and enables accurate tracking of any changes made to this information. Artificial intelligence (AI) may be utilized for generating 3D models of products based on 2D images of the products. Smart contracts may be utilized to conduct transactions between merchants and customers.

As an example, a customer may shop for clothing by browsing different stores in a virtual shopping mall via a wearable AR device, such as a pair of smart glasses. The customer may examine a 3D model of a shirt as he or she would in the real world. Additionally, the customer may virtually try on the shirt using a 3D model of the customer's body. If the customer decides to purchase the shirt, the customer may initiate a transaction with the merchant of the store. A transaction may be submitted to the blockchain via the customer's digital wallet to transfer money (cryptocurrency) from the customer to the merchant. Various smart contracts may be utilized to implement various aspects of the e-commerce process. For example, based on detecting that the sale price of the shirt has been successfully transferred from the customer to the merchant, a smart contract may be executed to initiate shipment of the shirt from the merchant's warehouse to the customer. As described above with reference to supply chain monitoring and tracking, RFID tags and other IoT devices may be utilized to track the shipment of the shirt from the merchant's warehouse to the delivery of the shirt to the customer's residence.

Quantum Computing

One of the concerns of quantum computing is that it may increase the probability of breaking cryptographic algorithms and thus, weaken overall security for the blockchain. This may be addressed by requiring larger key sizes for blockchain asymmetric-key pairs of cryptographic algorithms. In some cases, if there is a concern that a block may be decrypted in the future, a dynamically changing cryptographic hash may be utilized. A different cryptographic hash may be dynamically selected for a particular block or the entire blockchain based on various factors, such as whether there is a concern that the block will be decrypted in the future, increasing a strength of the hash, utilizing a hash that is better suited for protecting privacy. In some cases, different cryptographic hashes may be selected for different blocks.

Anonymity and Privacy

As discussed above, the use of a private/public key pair to establish user authenticity during validation of a blockchain transaction provides some privacy as it does not reveal user identity. However, the transactions stored on a blockchain may be visible to the public. It has been shown that user identity may be derived from the publicly available transaction information.

Blockchain Size

Depending on a frequency at which events are recorded in a blockchain, the size of the blockchain may grow quickly. Computing/storage capacity (i.e., faster processors, larger storage components) may be needed to support the expansion of the blockchain. In some cases, blocks may be compressed prior to being added to the chain. In some cases, blocks may be eliminated, for example, at the beginning of the blockchain, when they become stale or irrelevant. As an example, a method for “replacing” the first 1000 transactions with a new block that effectively mimics the hash of the 1000 transactions may be useful for managing blockchain size.

Blockchain Immutability

In some cases, content in a blockchain may need to be deleted. For example, content may need to be deleted if there is a security breach or if the content is no longer relevant. A level of immutability of a blockchain may depend on a type of the blockchain. For example, changing content may be difficult in a public blockchain due to its possible impact on a large number of users. According to some techniques, data stored in a private blockchain, or a public blockchain controlled by a few entities may be changed by recording a flag (current block) where the change is being made, and adding the current block (referred to by the flag) to the blockchain. The added block may then indicate the change made to the previous block.

As another example, a blockchain may need to be changed to resolve a broken link. For example, the hash of a changed block may no longer match the hash stored in the block+1. In some cases, the blockchain may need to be changed in order to reverse the results of illegal transactions. In some cases, the blockchain may need to be changed to address software errors, erroneous transactions, or remove information that is confidential or required by law to be removed. If the blockchain is immutable, these errors and information may be permanently embedded in the blockchain. Additionally, the blockchain may need to be changed to comply with regulatory concerns, such as the European Union's incoming General Data Protection Regulation (GDPR), or California Consumer Privacy Act (CCPA), regarding consumer data privacy and ownership rights, US Fair Credit Reporting Act, and the SEC's “Regulation SP,” which require that recorded user identifiable personal financial data be redactable.

Some techniques may allow modifications to the blockchain to address software errors, legal and regulatory requirements, etc., by allowing designated authorities to edit, rewrite or remove previous blocks of information without breaking the blockchain. Such techniques may enable blockchain editing by using a variation of a “chameleon” hash function, through the use of secure private keys. This editing may allow smart contracts that were flawed at issue to be updated so that the changes carry over to subsequent smart contracts in the blockchain. Using these techniques, blocks that have been changed may be using a “scar” or mark that cannot be removed, even by trusted parties.

According to some techniques, when a block is hashed, any confidential information, such as personally identifiable information, and IP addresses, is not included in the hash because it is not part of the data values that were hashed. But because there is no hash of the confidential information, it may be changed. According to some techniques, the confidential information may not be placed or recorded into the blockchain. Rather the information may reside in a file that is external to the blockchain. A hash of that file, however, may be recorded in the blockchain. For example, a user's confidential information may be deleted locally without affecting the blockchain.

As another example, assuming that all content included in a block in a blockchain cannot be changed after a block is added to the blockchain, a determination may be made before adding data to the blockchain of whether some or all of that data may need to be deleted at a later time. For example, confidential information (i.e., data to be deleted at a later time) may be stored as a file that is external to the block and the blockchain. For the purposes of creating the block, a link to the file containing the confidential information and a hash of the file containing the confidential information file may be added to the block. An example of a link would be an HTTP link. During confirmation of the block that is to be added to the blockchain, the network nodes may be able to access the confidential information and verify that the confidential information based on the hash value of the file in the block. Because the hash value of the file is a part of the block, the file containing the confidential information may not be easily changed. However, it may be possible to change the confidential information file by changing the data therein and adding a nonce. This may seek to change the nonce until the resulting hash equals the hash that is stored in the blockchain. However, this would be difficult (probably near impossible), and an inspection of the modified confidential information file would reveal the added nonce, which may then raise suspicion that information was changed since it was first added to the blockchain.

Files containing confidential information may be encrypted (e.g., through an asymmetric key encryption function) prior to the hashing operation. When “deleting” the confidential information, the file containing the confidential information may be deleted or removed resulting in the link, which is stored in the blockchain, being ineffective for retrieving the file. The hash of the file, and the link, remain in the blockchain so that the linking of the blocks through hash functions is not affected. However, because of this change, a transaction that is part of the block or part of a different special block could be added to the blockchain to indicate that the link is no longer effective, and the confidential information file is no longer part of the blockchain. This may effectively keep confidential information out of the blockchain while providing the confidential information to users of the blockchain and proof of authenticity of the confidential information before it is deleted from the blockchain. This may come with drawbacks because access to data implies that such data may be stored. Accordingly, those with access to the confidential information file, while it was part of the blockchain, may have stored that information in another location that may no longer be reachable during the “deleting” operation discussed above.

51% Attack

A “51% attack” refers to an individual mining node or a group of mining nodes controlling more than 50% of a blockchain network's mining power, also known as hash rate or hash power. The hash rate is a measure of the rate at which hashes are being computed on the blockchain network. As described above, hashing may include taking an input string of a given length, and running it through a cryptographic hash function in order to produce an output of a fixed length. A blockchain network's hash rate may be expressed in terms of 1 KH/s (kilohash per second) which is 1,000 hashes per second, 1 MH/s (megahash per second) which is 1,000,000 hashes per second, 1 TH/s (terahash per second) which is 1,000,000,000,000 hashes per second, or 1 PH/s (petahash per second) which is 1,000,000,000,000,000 hashes per second. As an example, a mining node in a blockchain utilizing a proof of work consensus model (PoW) may perform hashing in order to find a solution to a difficult mathematical problem. The hash rate of the mining node may depend on the computational resources available to that node. A mining node that successfully solves the mathematical problem may be able to add a block to the block-chain. Thus, by ensuring that invalid transactions cannot be included in a block, mining nodes increase the reliability of the network. Transactions may be deemed invalid if they attempt to spend more money than is currently owned or engage in double spending. If a mining node intentionally or unintentionally includes an invalid transaction in a block, then the block will not be validated by the network. Additionally, nodes that accept the invalid block as valid and proceed to add blocks on top of the invalid block will also end up wasting computational resources. Thus, mining nodes are discouraged from cheating by intentionally adding invalid transactions to blocks and accepting invalid-blocks as valid.

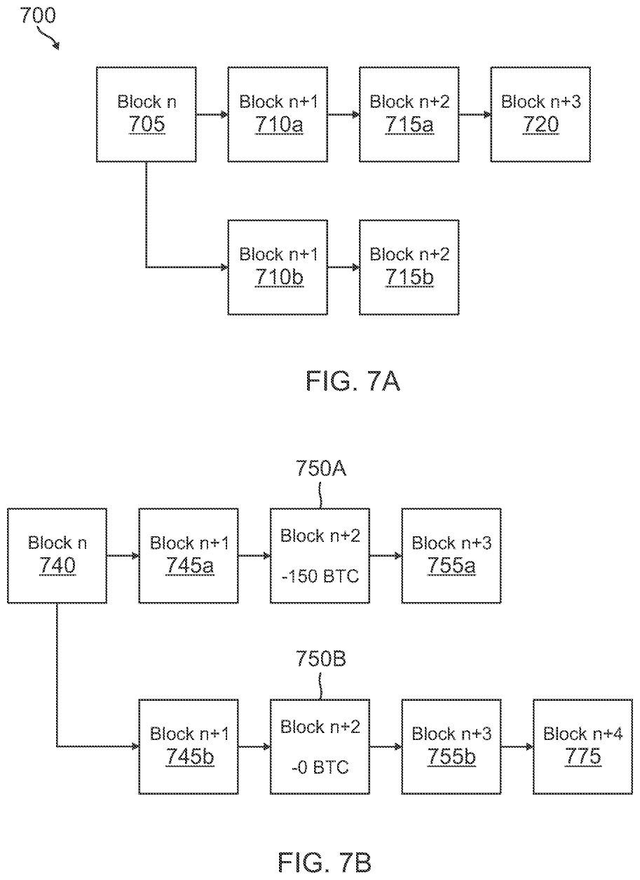

An entity may be able to disrupt the network by gaining control of 50% of a network's hash rate. In a 51% attack, a blockchain node may intentionally reverse or overwrite transactions and engage in double spending. When a node generates a valid block of transactions, it broadcasts the block to the network for validation. In some cases, a node controlling more than 50% of a network's hash rate may mine blocks in private without broadcasting them to the network. In such a scenario, the rest of the network may follow a public version of the blockchain while the controlling node may be following its private version of the blockchain. FIG. 7A shows a fraudulent and valid version of a blockchain 700. The valid blockchain on the top comprises the valid blocks 705, 710a, 715a, and 720. The fraudulent blockchain on the bottom is not broadcast to the network and includes the blocks 705, 710b, 715b, and an invalid block 720.

FIG. 7B shows another fraudulent and valid version of a blockchain. The valid version of the blockchain includes nodes 740, 745a, 750a, and 755a. The fraudulent version of the blockchain includes nodes 740, 745b, 750b, 755b, and 775. However, following the longest chain rule, the network may select and utilize the private or fraudulent blockchain comprising nodes 740, 745b, 750b, 755b and 775. Since it is the longest chain, previous transactions may be updated according to this chain. The cheating node may include transactions that spend money, such as the block 750b including the transaction for 150 BTC, on the public or fraudulent version of the blockchain without including these transactions in the private version of the blockchain. Thus, in the private version of the blockchain, the cheating node may continue to own the spent 150 BTC. When the cheating node controls more than 50% of the hashing resources of the network, it may be able to broadcast its private version of the blockchain and continue to create blocks on the private blockchain faster than the rest of the network, thus, resulting in a longer blockchain. Since there are two versions of the blockchain, the network may select the longest or fraudulent private blockchain as the valid blockchain. As a result, the rest of the network may be forced to use the longer blockchain. The public or valid version of the blockchain may then be discarded or abandoned and all transactions in this blockchain that are not also in the private or fraudulent version of the blockchain may be reversed. The controlling or cheating node may continue to own the spent money because the spending transactions are not included on the fraudulent version of the blockchain, and the cheating node may therefore, spend that money in future transactions.

Because of the financial resources needed to obtain more hashing power than the rest of the entire network combined, a successful 51% attack may generally be challenging to achieve. However, it would be less expensive to achieve a 51% attack on a network with a lower hash rate than one with a higher hash rate. Additionally, the probability of a successful 51% attack increases with the use of mining pools in which multiple nodes may combine their computational resources, for example, when mining is performed from the same mining pool.

### DESCRIPTION OF EXEMPLARY EMBODIMENTS

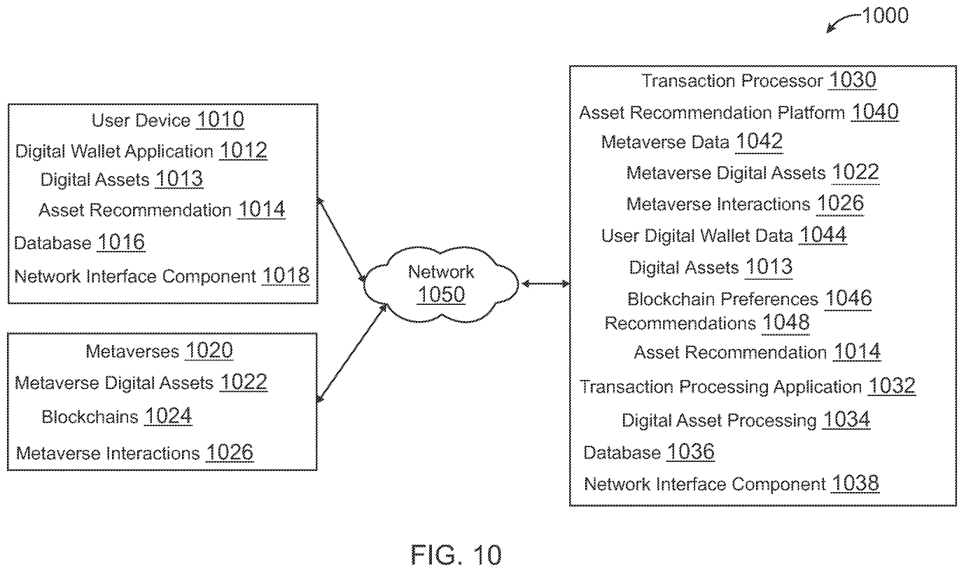

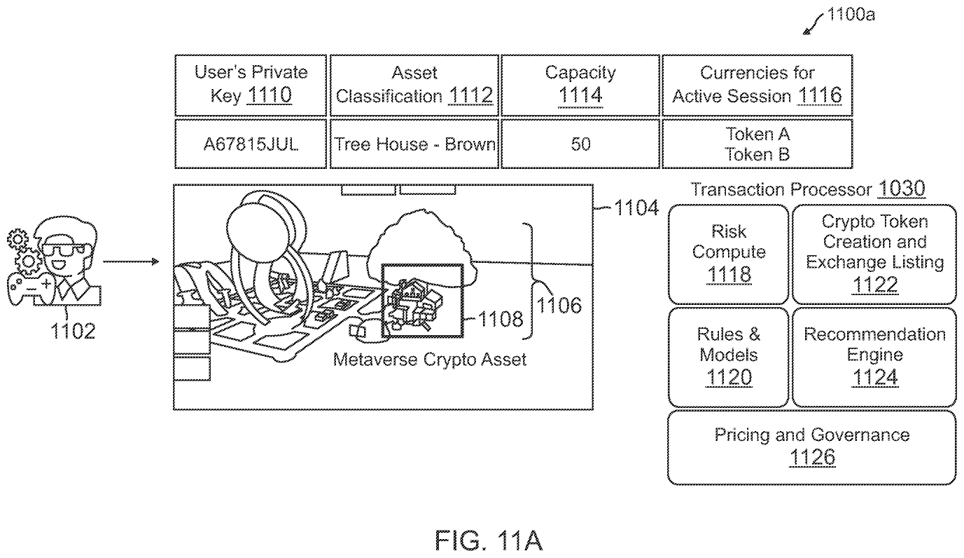

FIG. 10 is a block diagram of a networked system 1000 suitable for implementing the processes described herein, according to an embodiment. As shown, system 1000 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 10 may be deployed in other ways, and that the operations performed, and/or the services provided by such devices and/or servers, may be combined or separated for a given embodiment and may be performed by a greater number or fewer number of devices and/or servers. One or more devices and/or servers may be operated and/or maintained by the same or different entities.

System 1000 includes a user device 1010, metaverses 1020, and a transaction processor 1030 in communication over a network 1050. User device 1010 may be used to interact with metaverses 1020 and/or process transactions using transaction processor 1030. During metaverse interactions, metaverses 1020 may engage with user device 1010, where a user may perform interactions within one or more of metaverses 1020. Transaction processor 1030 may facilitate recommendations for digital assets within one or more of metaverses 1020 to user device 1010, where transaction processing for those digital assets may be performed through transaction processor 1030.

User device 1010, metaverses 1020, and transaction processor 1030 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 1000, and/or accessible over network 1050.

User device 1010 may be implemented using any appropriate hardware and software configured for wired and/or wireless communication with metaverses 1020 and/or transaction processor 1030 for processing payments and transactions including purchasing, selling, or otherwise transacting with digital assets. User device 1010 may correspond to an individual user, consumer, or merchant that utilizes a payment network and platform provided by transaction processor 1030 to process those transactions associated with metaverses 1020. In various embodiments, user device 1010 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing devices may function similarly.

User device 1010 of FIG. 10 contains a digital wallet application 1012, a database 1016, and a network interface component 1018. Digital wallet application 1012 may correspond to executable processes, procedures, and/or applications with associated hardware. In other embodiments, user device 1010 may include additional or different software as required.

Digital wallet application 1012 may correspond to one or more processes to execute modules and associated devices of user device 1010 to provide a convenient interface to permit a user of user device 1010 to enter, view, and/or process transactions, such as by using a digital wallet having digital assets 1013. In this regard, digital wallet application 1012 may correspond to specialized hardware and/or software utilized by user device 1010 that may provide digital wallet services to hold and/or utilize digital assets 1013 during electronic transaction processing and/or interactions in metaverses 1020. Digital assets 1013 may be available to the user in a digital wallet accessible via digital wallet application 1012 and/or via one or more of metaverses 1020, and may further be used to transact on digital platforms (e.g., exchanges) and/or with real-world devices (e.g., POS devices, merchant or financial services devices, etc.). In some embodiments, the transaction may be to process a payment or sale of one or more of digital assets 1013, where those transactions may be based on an asset recommendation 1014. Purchase, sale, and/or transfer of digital assets 1013, including those in one or more of metaverses 1030 may be done through a user interface enabling the user to enter and/or view an amount of funds or other digital assets to be paid or received for a digital asset being recommended by asset recommendation 1014. This may be based on a transaction generated by digital wallet application 1012 for digital assets available in and/or through metaverses 1020. For example, a transaction may be generated by transaction processor 1030, or electronic transaction processing may be requested when user device 1010 and metaverses 1020 interact to perform electronic transaction processing, based on asset recommendation 1014. Digital wallet application 1012 may also be used to receive a receipt or other information based on transaction processing.

In this regard, digital wallet application 1012 may be used to receive an offer and/or extension of asset recommendation 1014 for one or more digital assets and/or underlying virtual objects or components (e.g., which may be turned into a digital asset, such as an NFT). The offer may be in response to determining interactions by the user corresponding to user device 1010 in metaverses 1020, as well as an affinity or preference the user may have or may be learned for the user for one or more blockchains corresponding to digital assets. For example, based on digital assets 1013, one or more blockchains may correspond to those digital assets for purposes of transaction and/or ownership recordation, proof or validity, and the like. Transaction processor 1030 may run an analysis to determine whether to generate a recommendation and/or extend an offer for one or more digital assets available in one or more of metaverses 1020. Thereafter, asset recommendation 1014 or another notification may be provided to the user via digital wallet application 1012, which may include a link, selectable button or icon, executable operation, and/or user interface element that allows for the user to accept and/or purchase the corresponding digital asset, initiate transaction processing using the available cryptocurrency or other of digital assets 1013 from the users digital wallet, and acquire the digital asset for one or more of metaverses 1020. Digital wallet 1014 may be used to provide the amount for purchase of the digital asset associated with asset recommendation 1014, as well as manage the digital asset, such as for use with metaverses 1020. In various embodiments, digital wallet application 1012 may correspond to a general browser application configured to retrieve, present, and communicate information over the Internet (e.g., utilize resources on the World Wide Web) or a private network. For example, digital wallet application 1012 may provide a web browser, which may send and receive information over network 1050, including retrieving website information, presenting the website information to the user, and/or communicating information to the website, including payment information for the transaction. However, in other embodiments, digital wallet application 1012 may include a dedicated application of transaction processor 1030 or other entity (e.g., one or more of metaverses 1020), which may be configured to assist in processing transactions, such as a mobile application on a mobile device.

User device 1010 may further include database 1016 which may include, for example, identifiers such as operating system registry entries, cookies associated with digital wallet application 1012 and/or other applications, identifiers associated with hardware of user device 1010, or other appropriate identifiers. Identifiers in database 1016 may be used by a payment/service provider to associate user device 1010 with a particular account maintained by the payment/service provider. Database 1016 may also further store received transaction data and/or data for transactions associated with digital assets 1014, as well as received recommendations including asset recommendation 1014. In some embodiments, where the digital wallet of the user does not reside with a digital asset exchange and/or management platform, such as transaction processor 1030 or another exchange platform associated with metaverses 1020, digital assets 1013 may be stored by database 1016 or another accessible storage device (e.g., a cold wallet having stored private keys and the like for digital assets 1013).

User device 1010 includes at least one network interface component 1018 adapted to communicate with metaverses 1020, transaction processor 1030, and/or other devices or servers over network 1050. In various embodiments, network interface component 1018 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Metaverses 1020 may be maintained, for example, by online service providers, social networking and/or media providers, virtual reality platforms, video games and virtual worlds, and the like for providing online spaces, locations, and/or virtual worlds where users may interact. Metaverses 1020 may correspond to one or more websites, online platforms, virtual reality worlds, video games, or the like that present a 3D or other environment. Metaverses 1020 may therefore correspond to a simulated digital environment. In some embodiments, metaverses may utilize augmented reality and/or virtual reality, such as through wearable computing devices and/or device displays, which may be used for user interactions and/or mimicking or simulating real-world and/or fantasy environments. Metaverses 1020 may utilize social networking and media, as well as user movements, speech, noises, and the like, to enable user to user interactions, and may further utilizes one or more blockchains to manage digital assets within metaverses 1020. In some embodiments, metaverses 1020 may be implemented as a single or networked set of computers, servers, or the like, and may be accessible via a PC, a smart phone, laptop computer, wearable computing device, and/or other types of computing devices. Although a plurality of metaverses are described, a single metaverse may similarly function as described herein.

Metaverses 1020 may further include corresponding virtual environments, as well as other platforms, websites, and resources, that may allow users to engage in electronic transaction processing, such as those associated with metaverse digital assets 1022 that are associated with blockchains 1024. Metaverse digital assets 1022 may correspond to digital assets available in one or more of metaverses 1020, including cryptocurrency, digital or virtual currencies (e.g., in-game money), NFTs, virtual assets or objects including virtual real-estate, or the like. In some embodiments, metaverse digital assets 1022 may include and/or be generated for virtual objects and/or components of a metaverse. For example, metaverse digital assets 1022 may be based on and/or generated from an image of a digital asset, video or other media content of the digital asset, a recreation of the digital asset, and/or computing code for the digital asset. In some embodiments, metaverse digital assets 1022 may also be changed or enhanced, such as by changing visual or non-visual features, code, type, etc. Each of metaverse digital assets 1022 may have a corresponding one of blockchains 1024, where blockchains 1024 are used to manage recording of transfer, transactions, ownership, and/or validity of metaverse digital assets 1022. Blockchains 1024 may also be associated with digital assets 1013 for the user of user device 1010 and/or may correspond to one or more preferred blockchains by that user. When users interact within metaverses 1020 with other users, objects, or other virtual components, metaverse interactions 1026 may result, which may be tracked and/or processed by transaction processor 1030. As such, metaverse interactions 1026 may correspond to interactions and other actions taken by users within metaverses 1020.

Transaction processor 1030 may be maintained, for example, by an online service provider, which may provide operations for recommending and/or processing transactions for digital assets associated with metaverses 1020. In such embodiments, transaction processor 1030 may interface with metaverses 1020 to allow user device 1010 to receive recommendations of digital assets and process transactions for those digital assets. Transaction processor 1030 includes one or more processing applications which may be configured to interact with user device 1010 and/or metaverses 1020 for digital asset management and/or recommendation. In one example, transaction processor 1030 may be provided by PAYPAL®, Inc. of San Jose, Calif., USA. However, in other embodiments, transaction processor 1030 may be maintained by or include another type of service provider.

Transaction processor 1030 of FIG. 10 includes an asset recommendation platform 1040, a transaction processing application 1032, a database 1036, and a network interface component 1038. Asset recommendation platform 1040 and/or transaction processing application 1032 may correspond to executable processes, procedures, and/or applications with associated hardware. In other embodiments, transaction processor 1030 may include additional or different modules having specialized hardware and/or software as required.

Asset recommendation platform 1040 may correspond to one or more processes to execute software using associated hardware components of transaction processor 1030 to determine and transmit recommendations 1048 to one or more users for metaverse digital assets 1022 available in metaverses 1020. In some embodiments, asset recommendation platform 1040 may correspond to a digital asset and/or cryptocurrency exchange, sale, and/or purchase platform where users may utilize cold (e.g., offline) and/or hot (e.g., online) digital wallets to engage in digital asset purchases, sales, and/or transfers with other users, as well as perform electronic transaction processing for and/or using digital assets. Asset recommendation platform 1040 may receive metaverse data 1042 and user digital wallet data 1044, which may be used to determine recommendations 1048 using one or more ML or other data models and/or engines. For example, metaverse data 1042 may include metaverse digital assets 1022 from metaverses 1020 and metaverse interactions 1026 from metaverses 1020. User digital wallet data 1044 may include digital wallet data and/or available digital assets in digital wallets, such as digital assets 1013 for the user associated with user device 1010 and corresponding blockchain preferences 1046 based on affinity or preferences to use certain blockchains (e.g., based on blockchains corresponding to digital assets 1013).

One or more ML models may be trained to take, as input, at least metaverse data 1042 (e.g., metaverse interactions 1026 for a user associated with user device 1010) and user digital wallet data 1044 (e.g., blockchain preferences 1046 for the user), and output a recommendation of a predicted digital asset of interest to the user. ML models may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models that attempt to classify or predict recommendations 1048 based on metaverse data 1042 and user digital wallet data 1044 (e.g., at least metaverse interactions 1026 and/or blockchain preferences 1046 for one or more users). These predicted recommendations 1048 may correspond to metaverse digital assets 1022 that may be purchased or acquired.

Thus, when ML models are used to perform a predictive analysis and output, the input may provide a corresponding output based on the classifications, scores, and predictions trained for ML models. The output may correspond to a recommendation and/or action that transaction processor 1030 may provide to user device 1010 and/or other devices, as well as within metaverses 1020. By providing training data to train ML models, the nodes in the hidden layer may be trained (adjusted) such that an optimal output (e.g., a classification) is produced in the output layer based on the training data. By continuously providing different sets of training data and penalizing ML models when the output of ML models is incorrect, ML models (and specifically, the representations of the nodes in the hidden layer) may be trained (adjusted) to improve its performance in data classification. Adjusting ML models may include adjusting the weights associated with each node in the hidden layer. Thus, the training data may be used as input/output data sets that allow for ML models to make classifications based on input attributes.

Once trained and/or created, the ML or other data models (e.g., rules-based engines, etc.) may be used to generate recommendations 1048 based on metaverse data 1042 and user digital wallet data 1044. For example, asset recommendation 1014 may be generated based on one or more data models, and may be provided to user device 1010 and/or accessible to user device 1010 in one or more of metaverses 1020. Asset recommendation 1014 may be based on at least on metaverse interactions 1026 for the user corresponding to user device 1010 and blockchain preferences 1046 for that user. The one(s) of blockchain preferences 146 for the user may be based on digital assets 1013 and their corresponding blockchains and/or preferences set by the user. Additional data may further be used in generating recommendations 1048, such as metaverse interactions 1026 by other users with one or more of metaverse digital assets 1022, digital asset preferences, available funds or cryptocurrency, and the like.

Thereafter, asset recommendation 1014 may be provided to the user associated with user device 1010. This may be done by transmitting via one or more communication channels to user device 1010 and/or providing accessible in one or more of metaverses 1020. Further, asset recommendation 1014 may be tokenized, where a digital token may be generated with a TTL and price based on the digital asset and/or interactions with that asset for asset recommendation 1014 (e.g., based on a POI based pricing model). Such token parameters may be updated based on further interactions with the digital asset in metaverses 1020. If the user requests (e.g., via user device 1010 and/or metaverses 1020) a purchase of the digital asset for asset recommendation 1014, transaction processing application 1032 may be used for electronic transaction processing and acquisition of the digital asset. A corresponding blockchain may be updated by one or more devices, such as by pushing and/or requesting processing and recordation on the blockchain from one or more nodes of the distributed network by user device 1010, metaverses 1020, and/or transaction processor 1030. Additionally, ownership, such as a private key or the like that may be used to exchange the digital asset, as well as an underlying virtual object, component, or computing code in one or more of metaverses 1020 may be provided to the digital wallet of the user and accessible via digital wallet application 1012 and/or metaverses 1020. The operations and features of asset recommendation platform 1040 are described in further detail with regard to FIGS. 11A-13 below.

Transaction processing application 1032 may correspond to one or more processes to execute software using associated hardware components of transaction processor 1030 to process a transaction and/or exchange of an amount of funds for purchase of digital assets. In some embodiments, transaction processing application 1032 may be used by a user associated with user device 1010 to establish an account and/or digital wallet, which may be used to process transactions and/or buy, sell, or transfer digital assets. In various embodiments, an amount of funds in one or more currencies may be established for the account, as well as digital assets that may be maintained and used with the account. A digital token for the wallet may be used to send and process payments, for example, through an interface provided by transaction processor 1030. The digital wallet may be accessed and/or used through a browser application/extension and/or dedicated payment application executed by user device 1010 and engage in electronic transaction processing, such as using cryptocurrency and/or through other real or digital assets. In various embodiments, transaction processing application 1032 may be used to access digital assets for use in processing transactions. In this regard, user device 1010 may establish one or more of transactions, which may be performed through metaverses 1020. In other embodiments, one or more transactions may correspond to payment request(s) for purchase of digital assets associated with recommendations 1048 for metaverse digital assets 1022 associated with metaverses 1020.

In this regard, transaction processing application 1032 may interface with asset recommendation platform 1040 when obtaining a request for digital asset processing 1034. Digital asset processing 1034 may be for a digital asset recommended to the user associated with user device 1010 from asset recommendation 1014. Digital asset processing 1034 may provide an amount of funds, in a fiat, digital currencies or cryptocurrency, or the like, as well as other digital assets (e.g., NFTs). Digital asset processing 1034 may then process a transaction to acquire the corresponding digital asset and may update a blockchain ledger by publishing and requesting recordation of the transaction, ownership transfer, and the like on the corresponding blockchain of the digital asset. Transaction processing application 1032 may then acquire a private key or other ownership token that may be used to further transact and/or transfer the digital asset, which may be made available to the corresponding user's digital wallet.

Additionally, transaction processor 1030 includes database 1036. Database 1036 may store various identifiers associated with user device 1010. Database 1036 may also store account data, including payment instruments and authentication credentials, as well as transaction processing histories and data for processed transactions. Digital wallets, such as one available to and/or associated with user device 1010 may be stored by database 1036. Digital wallet, stored by database 1036, may include data for accounts used for transaction processing and/or digital asset usage, including cryptocurrency, NFTs, other digital assets available via metaverses 1020, access rights and/or permissions to digital assets, and the like.

In various embodiments, transaction processor 1030 includes at least one network interface component 1038 adapted to communicate with user device 1010, metaverses 1020, and/or another device/server for a merchant over network 1050. In various embodiments, network interface component 1038 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 1050 may be implemented as a single network or a combination of multiple networks. For example, in various embodiments, network 1050 may include the Internet or one or more intranets, landline networks, wireless networks, and/or other appropriate types of networks. Thus, network 1050 may correspond to small scale communication networks, such as a private or local area network, or a larger scale network, such as a wide area network or the Internet, accessible by the various components of system 1000.

Although various components of system 1000 are described separately, functionality of the various components may be combined and/or performed by a single component and/or multiple computing devices in communication without departing from the invention.

FIG. 11A illustrates an exemplary environment 1100a of a metaverse where digital assets may be recommended to users based on interactions and blockchain preferences, according to an embodiment. In environment 1100a, a user 1102 may interact with a metaverse 1104 which may correspond to an online digital environment where users may interact with objects, other users, activities, events, and the like. User 1102 may utilize a user device to interact with metaverse 1104, where the user device and metaverse 1102 may generally correspond to user device 1010 and/or metaverses 1020, respectively, from system 1000 of FIG. 10.

During an active metaverse session of user 1102 with metaverse 1104, metaverse components 1106 may be presented to user 1102, such as loaded into a digital environment where user 1102 may interact with metaverse components 1106. In some embodiments, metaverse components 1106 may include a digital asset 1108, which user 1102 may have interacted with during one or more metaverse sessions including the active session. In this regard, user 1102 may have one or more tracked user interactions by the user in at least metaverse 1106 with digital asset 1108. These interactions may indicate an interest with digital asset 1108. Digital asset 1108 may correspond to cryptocurrency or a representation of cryptocurrency, an NFT, a virtual object that may be represented by an NFT, a recreation and/or data for a recreation (e.g., computer code) for a virtual object that may be captured and/or represented as an NFT or another exchangeable asset or smart contract, and the like. For example, in environment 1100a, digital asset 1108 may correspond to an NFT representing a treehouse (e.g., an image, video, other media, token, etc.). In some embodiments, digital asset 1108 and/or the underlying virtual component of metaverse 1104 may be enhanced, such as by changing the parameters, characteristics, or the like of digital asset 1108.

During the active session of user 1102 in metaverse 1104, data may be provided for user 1102, metaverse 1104, and/or digital asset 1108. For example, a user's private key 1110 may denote the user's identity or the like in metaverse 1104 and be used for registering and/or exchanging assets on one or more blockchains for metaverse 1104 including digital asset 1108. An asset classification 1112 may correspond to information, metadata, and the like that classifies digital asset 1108, such as “Tree House—Brown” for digital asset 1108. Capacity 1114 may designate a capacity or number of digital asset 1108, such as a number that may exist of an NFT or the like. Finally, currencies for active session 1116 may denote that available digital currencies or other digital assets of user 1102, such as those that may be available within a digital wallet and/or used by the user. Currencies for active sessions 1116 may have corresponding blockchains used by the digital assets, which may be used to determine a preference or affinity of user 1102 for one or more blockchain technologies or protocols (as well as their corresponding digital assets).

Using the aforementioned data in environment 1100a, transaction processor 1030 may utilize a set of components to recommend digital asset 1108 to user 1102. Recommendation of digital asset 1108 to user 1102 may be based on available data from environment 1100a, as well as additional detected data such as interactions with digital asset 1108, desirable or preferred blockchains, and the like. Further, transaction processor 1030 may include a risk compute 1118 that may perform an initial risk analysis on user 1102, metaverse 1104, and/or digital asset 1108, as well as later transaction processing and digital asset acquisition requests. Risk compute 1118 may further determine, upon user 1102 joining metaverse 1104 for the current metaverse session, may perform a risk analysis of the digital assets owned (or predicted to be owned by) the cryptocurrency, tokens, NFTs, and/or other digital assets held by user 1102. These may be the digital assets that user 1102 may use to trade within metaverse 1108 and/or based on digital assets in metaverse 1108.

Rules and models 1120 may correspond to ML or other data rules and models used by rules-based and/or ML-based engines to recommend digital assets to users including digital asset 1108 to user 1102. A crypto token creation and exchange listing 1122 may be used in order to create and/or identify digital asset 1108 and/or corresponding NFT or the like from a listing and in order for user 1102 to purchase digital asset 1108. Recommendation engine 1124 may then utilize rules and models 1120 with a determination of digital asset 1108 from crypto token creation and exchange listing 1122 to recommend digital asset 1108 to user 1102. In addition, a pricing and TTL of a recommendation and/or digital token for the recommendation may be set, monitored, and adjusted using pricing and governance 1126, which may include a POI based pricing model based on interactions with digital asset 1108.

FIG. 11B illustrates an exemplary diagram 1100b of an intelligent digital asset recommendation in one or more metaverses to a user, according to an embodiment. In diagram 1100b, which may correspond to operations performed by transaction processor 1030 from system 1000 of FIG. 10. In this regard, transaction processor 1030 may generate digital asset recommendations 1140 based on the data shown in diagram 1100b, such as based on the data and components from environment 1100a for FIG. 11A.

In diagram 1100b, initially an ML model and/or engine of transaction processor 1030 may take, as input, data for a user digital wallet 1142 of a user and metaverses 1146 in which the user has interacted. User digital wallet 1142 may include available digital assets and blockchains 1144 for the digital assets available to user digital wallet 1142, such as those owned by the user. User digital wallet 1142 may further include information including blockchain preferences, digital asset preferences, available funds and/or funding sources including cryptocurrency and other digital asset values, and the like. Metaverses 1146 for the corresponding user of user digital wallet 1142 may include user interactions 1148 by the user within one or more of metaverses 1146 and metaverse digital assets 1150. User interactions 1148 may include those with metaverse digital assets 1150, which may indicate an interest with those digital assets in order to recommend one or more of the digital assets to the user associated with user digital wallet 1142.

The ML or other data models may utilize user digital wallet 1142 and metaverses 1146 in order to determine blockchain preferences 1152 and digital asset preferences 1154. Blockchain preferences 1152 may be determined using available digital assets and blockchains 1144. For example, those digital assets in user digital wallet 1142 may utilize corresponding blockchains (e.g., certain blockchain types, protocols, or the like) for procedures such as asset and transaction recordation, ownership, validity, and the like, which may be recorded over a distributed network of nodes that allows for managing or ensuring the integrity of data blocks or ledger records. Thus, blockchain preferences 1152 may be preferences by the user to utilize certain blockchain protocols, which may be based on acquired assets, blockchain preferences, and the like. Additionally, digital asset preferences 1154 may be set by the user and/or based on the type or characteristics of the corresponding digital assets in user digital wallet 1142.

For digital asset recommendations 1140, the ML or other data models may further be used to determine new digital asset recommendation 1156 from at least blockchain preferences 1152 with user interactions 1148 from metaverses 1146. New digital asset recommendations 1156 may be based on metaverse digital assets 1150, such as to recommend a new digital asset 1158 from metaverse digital assets 1150. The ML model and/or engine may determine new digital asset recommendation 1156 further based on additional data, including other users' interactions, prices and/or availability and the like. Once new digital asset recommendation 1156 has been determined, a metaverse token 1160 may be generated, which may be transmitted to the user via a communication channel and/or made available in one or more of metaverses 1146. Metaverse token 1160 may be generated with price and availability parameters 1162 for purchase of new digital asset 1158, which may determine a TTL and/or price associated with metaverse token 1160. Further, additional metaverse interaction adjustments 1164 may change price and availability parameters 1162 based on further detected interactions by the user and other users with new digital asset 1158 in one or more of metaverses 1146, which may extend and/or shorten the TTL, as well as increase or decrease the price of new digital asset 1158.

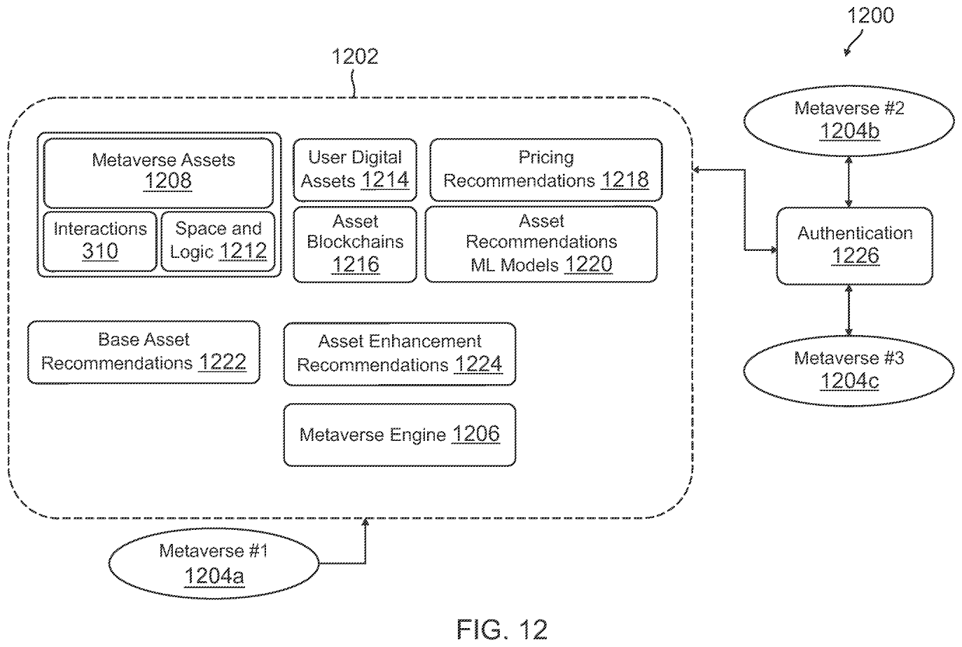

FIG. 12 illustrates exemplary block diagram 1200 of a system architecture for intelligent digital asset recommendations in metaverses to users, according to an embodiment. Diagram 1200 in FIG. 12 includes interactions between metaverses 1020 and transaction processor 1030 discussed in reference to system 1000 of FIG. 10. The interactions and components in diagram 1200 may be used to provide recommendations of digital assets to users based on their interactions within metaverses and preferred digital assets.

In this regard, an omniverse platform 1202 may be utilized to link and provide digital asset recommendations based on interactions in metaverse 1204a, 1204b, and 1204c. An omniverse may correspond to a collection of multiple metaverses, such as metaverses 1204a-c, and thus, omniverse platform 1202 may provide a connection and/or united metaverse between metaverses 1204a-c. Omniverse platform 1202 may include a metaverse engine 1206, which may process data from different ones of metaverses 1204a-c, such as interactions and available digital assets, that may be for recommendations to one or more users. As such, metaverse engine 1206 may serve as a bridge between different ones of metaverses 1204a-c.

Omniverse platform 1202 further includes metaverse assets 1208 from metaverses 1204a-c, which have interactions 310 based on interaction by users with metaverse assets 1208 in metaverses 1204a-c. When determining digital assets to recommend to users and/or parameters for metaverse assets 1208 for those recommendations, space and logic 1212 for metaverses 1204a-c may be used. For example, different metaverses may have different sizes, space constraints, themes, and/or other parameters that may influence recommendation of a digital asset to one or more users. Thus, metaverse assets 1208, determined by metaverse engine 1206, may be associated with multiple parameters that may be utilized when determining whether to recommend to one or more users.

To provide further outputs of recommendations to users based on interactions in metaverses 1204a-c, omniverse platform 1202 may utilize user digital assets 1214 with asset blockchains 1216. User digital assets 1214 may correspond to digital assets of users, which may be identified by their corresponding digital wallet. Further, each of user digital assets 1214 may have a corresponding one of asset blockchains 1216, which may be used to determine blockchain preferences and/or affinities of those users with certain blockchain protocols and/or technologies. Pricing recommendations 1218 may utilize a POI based on other pricing model to determine a value of a digital asset. The POI based pricing model may be based on a number and/or type of interaction by one or more users, including the user to which the recommendation is directed, with the underlying digital asset.

Asset recommendation ML models 1220 may then determine one or more asset recommendations for one or more users. This may be based on one or more ML models or other data models or rule-based engines for intelligent decision-making by one or more computing devices, servers, and/or cloud computing environments for omniverse platform 1202. Asset recommendation ML models 1220 may utilize, at least, interactions by a particular user with blockchain preferences for that user in order to determine base asset recommendations 1222, which may include one or more digital assets available via one or more metaverses to recommend to a user. Further, base asset recommendations 1222 may be enhanced using asset enhancement recommendations 1224, which may identify any enhancements to a base digital asset and/or underlying virtual component of a metaverse to change and/or increase value of in one or more metaverses.

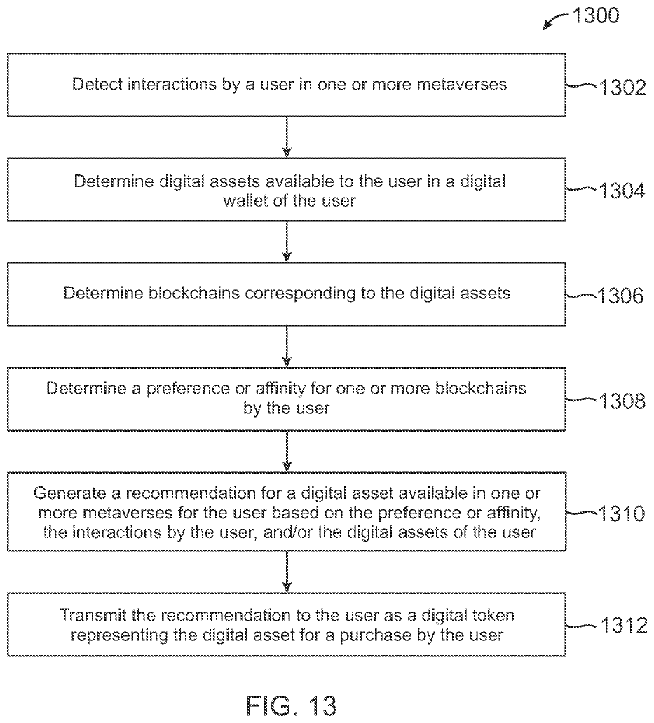

FIG. 13 illustrates a flowchart 1300 for an omniverse platform for predictive digital asset identification and recommendation in different metaverses, according to an embodiment. Note that one or more steps, processes, and methods described herein of flowchart 1300 may be omitted, performed in a different sequence, or combined as desired or appropriate.

At step 1302 of flowchart 1300, interactions by a user in one or more metaverses are detected. Interactions by users in metaverses may correspond to those interactions performed by and/or engaged in by the user in a metaverse during a metaverse session. For example, a user and/or representation of a user (e.g., avatar, playable character, etc.) may interact with a metaverse through augmented reality, virtual reality, and/or other digital displays of the metaverse, which may include real and/or virtual world environments. As the user engages with the metaverse, the user may come into proximity to and/or contact with other users, objects, locations, and the like. The user may also engage in communication, viewing of content or events, purchases or sales, uses of objects, and the like. These engagements with the metaverse may correspond to the interactions by the user with the metaverse(s). In some embodiments, after an interaction by the user with a digital asset within a metaverse, a smart contract may be created with the user's public key, public data, or the like, for a particular digital asset. This smart contract creation may further be dependent on whether other users further engage and/or interact with the digital asset, which may allow the user to receive alerts and/or notifications about digital assets of interest and/or that were interacted with by the user and thereafter other users, as well as later purchase the digital asset. In one or more embodiments, interactions by a user with other blockchain protocols and decentralized application may also be detected, for example, a user's interactions with a social media decentralized application, a financial application, or another decentralized application may be detected for the purposes of this step.

At step 1304, digital assets available to the user in a digital wallet of the user are determined. A transaction processor or other service provider may access and/or determine data for a digital wallet of the user, which may include identification and/or private keys of digital assets available to the user. The digital assets may include cryptocurrency, NFTs, and other assets that may be utilized in one or more metaverses. For example, cryptocurrency may be used as a currency in one or more metaverses, where NFTs may represent objects, events, users or characters, and/or other components of one or more metaverses. Further, NFTs may be used to exchange virtual assets and/or components between metaverses and/or be used to generate, recreate, and/or add virtual assets in a metaverse and/or between metaverses. Additional digital assets may also include smart contracts and/or other representations of ownership, possession, and/or control of virtual assets in metaverses (e.g., items in metaverses that may be used, virtual real-estate, etc.).

At step 1306, blockchains corresponding to the digital assets in the user's wallet are determined. Based on the user interacting with one or more metaverses, a transaction processor or other service provider may determine to provide a recommendation to the user of one or more digital assets for purchase, where the digital assets may be available in the metaverse(s) as well as outside the metaverse(s) (e.g., tradeable via one or more exchange platforms, used as an online or real-world form of currency, etc.). The transaction processor may therefore determine an intelligent recommendation of a digital asset that may be of interest for the user to purchase. To do this, the transaction processor may determine digital assets that have characteristics of interest to the user, including correspondence to a certain blockchain for a decentralized ledger to record transactions using the digital asset over distributed nodes, as well as interactions that may correspond to that digital asset (e.g., viewing, using, etc., in one or more metaverses). In other words, by identifying the blockchains corresponding to the digital assets in a user's wallet, the transaction processor may be able to determine the blockchains that are user has transacted with and is already set up to transact with. Therefore, this can be taken into account when recommending a digital asset (such as a metaverse asset), i.e., the transaction processor may only recommend digital assets that are associated with blockchains that have been identified as corresponding to the digital assets in the user's wallet.

At step 1308, a preference or affinity for one or more of the blockchains by the user is determined. The user may have an affinity or preference for use and/or digital assets associated with a particular blockchain. For example, a user may prefer a particular blockchain protocol and/or digital assets that utilize that blockchain for distributed recordation and a decentralized ledger of transactions between different users and entities. This may be based on the digital assets in possession of the user, such as those determined at step 1302 available to the digital wallet of the user. The preferred blockchains may be based on a most (or multiple most) common or used blockchain between the user's digital assets or may be learning based on the user's behavior over time. For example, if the user obtains and/or transacts using a digital asset with a particular blockchain more recently, that may be the preferred blockchain of the user. Conversely, if the user has a large portion of digital assets that correspond to a different blockchain, but rarely or not recently transacts using that digital asset, the blockchain may be determined to not be preferential to the user.

At step 1310, a recommendation for a digital asset available in one or more of the metaverses is generated for the user based on the preference or affinity, the interactions by the user, and/or the digital assets of the user (and the blockchains associated with those digital assets). The recommendation may be generated using at least the preferred blockchain of the user and the interactions by the user in one or more metaverses using one or more ML models or other data models or engines that may process the input data and provide an output of a predicted digital asset that may be of interest to acquire and/or purchase by the user. The predicted digital asset may be one that the user has interacted with, such as viewed and/or come into a proximity of during a metaverse session with one or more metaverses. The digital asset may be available in multiple metaverses or may be metaverse specific. For example, the user may visit a specific location and/or perform certain interactions that are affiliated with a digital asset, whether cryptocurrency, an NFT, and/or an underlying virtual component of a metaverse that has a corresponding digital asset (e.g., NFT represent an image, media of, etc. of the digital asset).

Further, the digital asset may be recommended to the user based on the blockchains that the user has a preference or affinity for from their digital assets. For example, a user may utilize Ethereum or Ethereum based NFTs, or may prefer Stellar, Corda, or the like based on the underlying blockchain technology, algorithm, and/or protocol. This may be apparent based on the digital assets acquired and/or utilized/traded by the user, such as different cryptocurrencies, NFTs, and the like. Thus, a preference learned at step 1308 may also be relevant to the determination of the digital asset to recommend to the user. The digital asset may also be recommended to the user based on the theme of the current metaverse and/or other metaverses of interest or visited by the user. For example, if the theme of a metaverse is fashion, gaming, gardening, etc., the digital asset may have a corresponding value dependent on that metaverse and/or other metaverses.

However, the digital assets of the user may also be used to determine the recommendation based on the availability of payment for a purchase of the digital asset, the same, similar, or different digital assets owned by the user, and the like. For example, the ML model may determine that the digital asset may be recommended to the user, however, the user lacks sufficient funds to pay for the digital asset and therefore should not be recommended. The user may also not be recommended the digital asset if the user already possess the same or similar digital asset, unless the digital asset may be a collectable where it may be desirable to possess multiple (e.g., certain NFT collections and the like).

When generating the recommendation of the digital asset, a POI based pricing model may be utilized to determine a price of the digital asset in one or more of the metaverses, The POI based pricing model may utilize user interactions, as well as any set values or prices (e.g., from past purchases or sales of the digital asset), to determine a price of the digital asset. The price may therefore be dynamic and may change over time, for example, based on changes in interactions with the digital asset. This may increase and/or decrease the value of the digital asset. The POI based pricing model may further use an arbitrage opportunity or sale between different metaverses to recommend the digital asset to the user and/or determine a price of the digital asset to the user. The determined price of the digital asset may also be used to determine the recommendation to the user, such as based on similar prices of purchase of other digital assets by the user.

At step 1312, the recommendation to the user is transmitted as a digital token representing the digital asset for a purchase by the user. The recommendation may be transmitted via an electronic communication channel, such as email, text, etc., as well as be populated within a metaverse as a message or object for interaction. In further embodiments, the recommendation may be tokenized as a digital token that may be transmitted to the user and/or presented via one or more metaverses. The digital token may have a TTL, as well as the determined price for purchase of the digital asset. Based on further interactions, or lack thereof, with the digital asset, the TTL and/or price associated with the digital token and recommendation of the digital asset may be adjusted, such as by lengthening or shortening, increasing or decreasing, respectively.

Thereafter, the user may elect to purchase or may disregard the recommendation. If a purchase of the digital asset is initiated, the transaction processor may process the transaction electronically using fiat currency, virtual currency, and/or digital assets, and may convey ownership of the digital asset to the user. The transaction processor and/or one or more other devices may broadcast the transaction for recordation in the distributed ledger of the blockchain across the blockchain nodes. In some embodiments, the user may also engage in a simulation and/or POI based pricing before making the purchase of the digital asset, such as by monitoring the price and/or interactions with the digital asset to determine the value of the digital asset. Thus, the user may not perform an outright purchase but may monitor and/or claim the digital token for the TTL in order to determine whether to purchase. This may also allow the transaction processor to charge a commission while the user engages in the simulation of the POI based pricing model of the digital asset, which may be charged on purchase and/or resell of the digital asset.

FIG. 14 is a block diagram of a computer system 5000 suitable for implementing one or more components in FIG. 10, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 5000 in a manner as follows.

Computer system 5000 includes a bus 5020 or other communication mechanism for communicating information data, signals, and information between various components of computer system 5000. Components include an input/output (I/O) component 5040 that processes a user action, such as selecting keys from a keypad/keyboard, selecting one or more buttons, image, or links, and/or moving one or more images, etc., and sends a corresponding signal to bus 5020. I/O component 5040 may also include an output component, such as a display 5110 and a cursor control 5130 (such as a keyboard, keypad, mouse, etc.). An optional audio input/output component 5050 may also be included to allow a user to use voice for inputting information by converting audio signals. Audio I/O component 5050 may allow the user to hear audio. A transceiver or network interface 5060 transmits and receives signals between computer system 5000 and other devices, such as another communication device, service device, or a service provider server via a network 1050, such as network 1050 of FIG. 10. In one embodiment, the transmission is wireless, although other transmission mediums and methods may also be suitable. One or more processors 5120, which can be a micro-controller, digital signal processor (DSP), or other processing component, processes these various signals, such as for display on computer system 5000 or transmission to other devices via a communication link 5180. Processor(s) 5120 may also control transmission of information, such as cookies or IP addresses, to other devices.

Components of computer system 5000 also include a system memory component 5140 (e.g., RAM), a static storage component 5160 (e.g., ROM), and/or a disk drive 5170. Computer system 5000 performs specific operations by processor(s) 5120 and other components by executing one or more sequences of instructions contained in system memory component 5140. Logic may be encoded in a computer readable medium, which may refer to any medium that participates in providing instructions to processor(s) 5120 for execution. Such a medium may take many forms, including but not limited to, non-volatile media, volatile media, and transmission media. In various embodiments, non-volatile media includes optical or magnetic disks, volatile media includes dynamic memory, such as system memory component 5140, and transmission media includes coaxial cables, copper wire, and fiber optics, including wires that comprise bus 5020. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 5000. In various other embodiments of the present disclosure, a plurality of computer systems 5000 coupled by communication link 5180 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
determining one or more digital assets available in a digital wallet of a user;
determining one or more interactions of the user in one or more metaverses; and
determining a recommendation of a first digital asset available in the one or more metaverse to recommend to the user, wherein the determining the recommendation is based on:
analyzing the one or more digital assets available in the digital wallet of the user and the one or more interactions of the user in the one or more metaverses,
determining one or more blockchains corresponding to the one or more digital assets,
determining a user preference for the one or more blockchains based on at least one of the one or more digital assets or the one or more interactions, and
identifying the first digital asset from a plurality of digital assets to recommend to the user based on the analyzing and the user preference, wherein the first digital asset corresponds to the determined user preference for the one or more blockchains.

2. The service provider system of claim 1, wherein the first digital asset comprises a non-fungible token (NFT) associated with a virtual object available within the one or more metaverses.

3. The service provider system of claim 2, wherein the determining the recommendation further comprises:
generating a digital token for a purchase of the NFT in the one or more metaverses at a first value, wherein the digital token further comprises a token time-to-live (TTL) for validity of the digital token for the purchase by the user of the NFT in the one or more metaverses.

4. The service provider system of claim 3, wherein the operations further comprise:
determining whether to update at least one of the first value of the digital token to a second value or the token TTL based on one or more additional interactions by the user or a plurality of additional users with the virtual object in the one or more of the metaverses after the generating the digital token.

5. The service provider system of claim 1, wherein the determining the recommendation further comprises:
predicting a value of the first digital asset to the user in the one or more of the metaverses based on at least one of the one or more digital assets, the one or more blockchains, or the one or more interactions, wherein the predicting uses a proof of interest pricing model based on the one or more interactions in the one or more of the metaverses, and wherein the recommendation comprises the value of the first digital asset.

6. The service provider system of claim 1, wherein the determining the recommendation further comprises:
determining that the first digital asset increases a value of a second digital asset of the one or more digital assets available in the digital wallet of the user in the one or more metaverses.

7. The service provider system of claim 1, wherein the first digital asset corresponds to a first interaction of the one or more interactions by the user, and wherein the determining the recommendation further comprises:
identifying a second interaction by an additional user with the first digital asset in the one or more metaverses,
wherein the identifying the first digital asset is further based on the second interaction.

8. The service provider system of claim 1, wherein the one or more digital assets available to the user in the digital wallet comprise at least one of cryptocurrency, NFTs, digital currency, or fiat currency.

9. The service provider system of claim 1, wherein the operations further comprise:
invalidating the recommendation for a purchase by the user of the first digital asset after an expiration of an amount of time.

10. The service provider system of claim 1, wherein the service provider system comprises a metaverse asset engine platform connecting the one or more metaverses and provides a space allocation and a space leasing in the one or more metaverses for at least one of the first digital asset, the one or more digital assets, or NFTs in the one or more metaverses.

11. The service provider system of claim 1, wherein the first digital asset comprises a digital representation of an object within the one or more metaverses, and wherein the digital representation comprises a plurality of parameters defining the first digital asset in the one or more metaverses.

12. The service provider system of claim 11, wherein the operations further comprise:
providing an asset enhancement recommendation of the plurality of parameters for the first digital asset in the one or more metaverses.

13. The service provider system of claim 1, wherein the determining the recommendation further comprises:
predicting the first digital asset is of interest to the user based on meeting or exceeding a threshold value in the one or more metaverses or a threshold arbitrage difference between different ones of the one or more metaverses.

14. The service provider system of claim 1, wherein the first digital asset comprises an NFT of one of an image of the first digital asset in the one or more metaverses, media content of the first digital asset in the one or more metaverses, a recreation of the first digital asset in the one or more metaverses, or computing code for the first digital asset in the one or more metaverses.

15. A method comprising:
determining one or more digital assets available in a digital wallet of a user;
determining one or more interactions of the user in one or more metaverses; and
determining a recommendation of a first digital asset available in the one or more metaverse to recommend to the user, wherein the determining the recommendation is based on:
analyzing the one or more digital assets available in the digital wallet of the user and the one or more interactions of the user in the one or more metaverses,
determining one or more blockchains corresponding to the one or more digital assets,
determining a user preference for the one or more blockchains based on at least one of the one or more digital assets or the one or more interactions, and
identifying the first digital asset from a plurality of digital assets to recommend to the user based on the analyzing and the user preference, wherein the first digital asset corresponds to the determined user preference for the one or more blockchains.

16. The method of claim 15, wherein the first digital asset comprises a non-fungible token (NFT) associated with a virtual object available within the one or more metaverses.

17. The method of claim 16, wherein the determining the recommendation further comprises:
generating a digital token for a purchase of the NFT in the one or more metaverses at a first value, wherein the digital token further comprises a token time-to-live (TTL) for validity of the digital token for the purchase by the user of the NFT in the one or more metaverses.

18. The method of claim 17, further comprising:
determining whether to update at least one of the first value of the digital token to a second value or the token TTL based on one or more additional interactions by the user or a plurality of additional users with the virtual object in the one or more of the metaverses after the generating the digital token.

19. The method of claim 15, wherein the determining the recommendation further comprises:
predicting a value of the first digital asset to the user in the one or more of the metaverses based on at least one of the one or more digital assets, the one or more blockchains, or the one or more interactions, wherein the predicting uses a proof of interest pricing model based on the one or more interactions in the one or more of the metaverses, and wherein the recommendation comprises the value of the first digital asset.

20. A non-transitory machine-readable medium having stored thereon machine-readable instructions executable to cause a machine to perform operations comprising:
determining one or more digital assets available in a digital wallet of a user;
determining one or more interactions of the user in one or more metaverses; and
determining a recommendation of a first digital asset available in the one or more metaverse to recommend to the user, wherein the determining the recommendation is based on:
analyzing the one or more digital assets available in the digital wallet of the user and the one or more interactions of the user in the one or more metaverses,
determining one or more blockchains corresponding to the one or more digital assets,
determining a user preference for the one or more blockchains based on at least one of the one or more digital assets or the one or more interactions, and
identifying the first digital asset from a plurality of digital assets to recommend to the user based on the analyzing and the user preference, wherein the first digital asset corresponds to the determined user preference for the one or more blockchains.
